(19) United States
(12) Patent Application Publication
(10) Pub. No.: US 2011/0227988 A1
(43) Pub. Date: Sep. 22, 2011

(54) FINE PATTERN POSITION DETECTION METHOD AND APPARATUS, DEFECTIVE NOZZLE DETECTION METHOD AND APPARATUS, AND LIQUID EJECTION METHOD AND APPARATUS

(76) Inventor: Yoshirou YAMAZAKI, Kanagawa-ken (JP)

(21) Appl. No.: 13/049,516

(22) Filed: Mar. 16, 2011

(30) Foreign Application Priority Data
Mar. 19, 2010 (JP) 2010-064597

(51) Int. Cl. B41J 29/393; H04N 1/00

(52) U.S. Cl. 347/19; 358/406

(57) ABSTRACT

A fine pattern position detection method includes: a reading step of reading line patterns formed on a recording medium, at a prescribed read pixel pitch in a prescribed reading direction to acquire read data; a read pixel position acquisition step of acquiring from the read data corresponding positions of the line patterns based on the read pixel pitch; a characteristic value acquisition step of acquiring, from the read data, characteristic values at the corresponding positions of the line patterns and characteristic values at adjacent pixel positions which are adjacent to each of the corresponding positions of the line patterns according to the read pixel pitch; a candidate position output step of applying the characteristic values at the corresponding positions of the line patterns and the characteristic values at the adjacent pixel positions, to a position table in which the characteristic value at each of the corresponding positions of the line patterns and the characteristic values at the adjacent pixel positions are associated with a candidate position which is a candidate position having highest possibility of arrangement of each of the line patterns and which is assigned at a distance shorter than the read pixel pitch from the corresponding position of each of the line patterns, so as to output the candidate position of each of the line patterns; and a recording position acquisition step of calculating a recording position of each of the line patterns on the recording medium, from the corresponding position of each of the line patterns based on the read pixel pitch and the output candidate position of each of the line patterns.

### BACKGROUND OF THE INVENTION

1. Field of the Invention

The present invention relates to a fine pattern position detection method and apparatus, a defective nozzle detection method and apparatus, and a liquid ejection method and apparatus, and more particularly, to technology for identifying a position of a line pattern on a recording medium with an accuracy of less than the read pixel pitch.

2. Description of the Related Art

One method of recording an image on a recording medium is an inkjet image formation method in which ink droplets ejected in accordance with an image signal are deposited on a recording medium. Among image formation apparatuses using this inkjet image formation method, there is a full line head type image formation apparatus in which an ejection unit (including a plurality of nozzles) which ejects ink droplets is arranged in a linear shape so as to correspond to the entire length of one edge of a recording medium, and the recording medium is conveyed in a direction perpendicular to the line arrangement of the ejection unit and an image is recorded over the whole area of a recording medium. A full line type image formation apparatus is suitable for raising the recording speed since such an apparatus is able to form an image over the whole area of the recording medium by conveying the recording medium without moving the ejection unit.

Since a full line type recording head of this kind has a length equal to or greater than the width of the recording paper, then if the recording resolution is 1200 dpi and the width of the recording paper is 27 inches, for example, this means that 32,400 nozzles of recording elements are provided for each type of ink, and if there are four types of ink, then the total number of nozzles is 129,600.

However, when using an image formation apparatus having a full line head, due to manufacturing variations, and the like, recording position errors may occur in the recording elements (nozzles) of the ejection unit, as a result of the actual dot positions recorded on a recording medium being displaced from the ideal dot positions. As a consequence of this, so-called banding or non-uniformities occur in the image recorded on the recording medium, which may lead to decline in the image quality.

In other words, an ideal recording head records dots at equidistant intervals on the recording medium, by means of recording elements which are arranged in a regular fashion. However, in an actual recording head, due to manufacturing variation in the recording elements, variation over time, or problems during maintenance, or the like, the actual dot depositing positions tend to have positional error (depositing position error) with respect to the ideal recording positions.

Consequently, when a recording element having a positional error equivalent to or more than one half of the pitch interval between the recording elements is driven, for example, then the effects on the image quality may become significant and it is beneficial in terms of image quality to avoid the use of such recording elements.

Technology which corrects an image on the basis of the dot depositing positions is known as technology for reducing image deterioration by correcting banding and non-uniformities. Furthermore, as technology for measuring error in the dot depositing positions, there is technology which forms a test pattern (line patterns) by operating respective nozzles at prescribed intervals apart, reads in the image of the test pattern using an image reading apparatus, and determines positional error by means of a prescribed detection algorithm from the reading results. The test pattern referred to here includes a plurality of dot lines formed on the recording medium by droplets ejected from nozzles, and the recorded dots on the recording medium reflect the ejection status of the corresponding nozzles (namely, the recording position error and density error thereof, and the like).

If there are recorded dots having a dot depositing position error close to the pitch between adjacent dots (the pitch between recording elements) (for example, in a recording head of 1200 dpi, the ideal dot pitch is 20.8 μm and therefore if the recording head has dot depositing position error of 10.4 (=20.8/2) μm or more), this can lead to deterioration of image quality. A recording element (nozzle) having a positional error close to the recording element pitch in this way is provisionally called a “defective ejection nozzle (defective recording element)”.

In actual practice, nozzles become defective ejection nozzles of this kind at various different times, for instance, there are recording elements which have a large depositing position error from the time of manufacture of the recording head, recording elements which develop large depositing position error due to temporal change over a long period of time, recording elements which are normal at the start of printing and in which the depositing position error changes greatly during the course of printing (including recording elements which return again to a normal range after maintenance), and recording elements which have developed large depositing position error due to defective maintenance (including recording elements which return to a normal range after another maintenance operation).

In order to prevent deterioration of image quality, it is necessary either to halt ink ejection from defective recording elements of this kind, or to correct the control of ink ejection. One method of detecting and correcting defective ejection nozzles in a timely fashion is a method in which a test pattern is formed on printing paper, and defective ejection nozzles are detected and image correction is performed while reading in the image of the test pattern during a printing operation.

### Relative Merits of Composition of Test Pattern

When recording paper is used specially for a test pattern, it is necessary to separate the test pattern from the paper which does not bear a test pattern, and the recording paper for a test pattern is consumed superfluously. Furthermore, if the time from the occurrence of a defective ejection nozzle until detection thereof is long (delayed), then the print results during that period will also contain problems in terms of image quality. In order to reduce this delay, it is necessary to improve the output frequency of the test pattern, but in cases of this kind, further recording paper is consumed for test patterns and hence this is uneconomic. However, if detection and correction are performed by creating a test pattern in a blank margin in an end portion of recording paper, then it is possible to suppress wasteful consumption of recording paper, and it is also possible to monitor positional error constantly, which prevents the problems described above from arising in principle.

### Problems of Test Pattern Design

In order to detect positional error in each recording element, the respective recording elements are operated independently at prescribed intervals apart, the continuous dots (line, line pattern) formed by these recording elements are read in by an image reading apparatus and the positional error is derived by performing calculation based on a prescribed detection algorithm.

In order to improve the accuracy of positional error detection, it is desirable to increase the pitch at which the line patterns constituting the test pattern are formed, as well as forming the continuous dots (line patterns) to be long. However, cases such as this are disadvantageous and bring further problems in that because the surface area of the test pattern is increased, then it is necessary to ensure a large blank margin for recording the test pattern, and hence the printing region which is available to the user is reduced. If a test pattern is formed in a blank margin in this way, then the region used for the test pattern needs to be made as small as possible, and therefore desirably the pitch between the line patterns in the test pattern is made narrow and the continuous dots (line patterns) are made short.

Problems with Image Reading Apparatus

It is beneficial in cost terms that the image reading apparatus which reads in the test pattern has as low a resolution as possible. In a high-resolution reading apparatus, overall costs rise due to increases in the lens costs, the quantity of irradiated light, the reading transfer clock, the volume of image data, and the algorithm processing volume.

The requirement to use a low-resolution image reading apparatus of this kind is not compatible with the requirement to narrow the continuous dots (line patterns) in the test pattern as described above.

### Algorithm

Therefore, in order to lower the cost of the image reading apparatus while narrowing the size of the test pattern, an algorithm is required to calculate positional error with high accuracy from a low-resolution read image.

Japanese Patent Application Publication No. 2000-135818 discloses a method of calculating a central position of a ruled line figure which is read in a multiple-value mode, and FIG. 6 in Japanese Patent Application Publication No. 2000-135818, in particular, describes a relationship between sampling points and the density distribution of ruled lines. However, since many reading apparatuses also have an aperture size, then the integrated value of the aperture size centered on the sampling point is obtained as the image reading result. Under reading conditions where the read pixel pitch is close to the pitch of the read object, the aperture effects make it impossible to ascertain the original density distribution by focusing on the sampling points alone (the sampling phase and the aperture size affect the results). Consequently, under reading conditions where the read pixel pitch is close to the pitch of the read object, it is difficult to determine the central position with good accuracy using the technology described in Japanese Patent Application Publication No. 2000-135818.

The technology described in Japanese Patent Application Publication No. 2008-182352 determines the position of a raster forming the tonal center of gravity of a plurality of rasters centered on a raster having a highest average tone value (see paragraph 0092 in Japanese Patent Application Publication No. 2008-182352). However, when using the tonal center of gravity, it is difficult to determine the central position of a raster under reading conditions where the read pixel pitch is close to the pitch of the read object.

FIG. 41 shows profiles in a case where the read pixel pitch is far from the read object pitch (where the read pixel pitch is fine) (2400 dpi). FIG. 42 shows profiles where the read pixel pitch is close to the read object pitch (500 dpi). FIG. 43 shows profiles where the read pixel pitch is close to the read object pitch (500 dpi) and where the read pixel pitch is far from the read object pitch (where the read pixel pitch is fine) (2400 dpi). In FIG. 41 to FIG. 43, the horizontal axis represents the read position (X coordinate (μm)) and the vertical axis represents the optical density (OD value).

As shown in FIG. 41 to FIG. 43, in reading results for the same profile, at 2400 dpi a state close to the original profile is observed, whereas at 500 dpi (including cases of sampling phase difference), a state which is greatly separated from the original profile is observed. Even if the sampling phase is altered, the expected value for each position is the same, but it is difficult to determine an accurate position with good precision on the basis of the tonal center of gravity.

As described above, technology of high reliability which is capable of accurately calculating ejection error of nozzles from a read image of a fine test pattern has not yet been discovered, and in particular, a method and an apparatus capable of accurately calculating the depositing position error of droplets from a low-resolution read image are desired.

Furthermore, in order to calculate ejection error for a very large number of nozzles, as in a full line head, a method and an apparatus employing an algorithm which is simple and requires only a short calculation time are desirable.

Furthermore, the measurement error that is intrinsic to the scanner (reading apparatus) is not necessarily the same between apparatuses, and a method and an apparatus capable of accurately calculating the depositing positions of droplets while also compensating for the intrinsic measurement error of a scanner are desirable.

### SUMMARY OF THE INVENTION

The present invention has been contrived in view of these circumstances, an object thereof being to provide technology capable of determining change in dot depositing positions with uniform accuracy, even if the resolution (read pixel pitch) of the image reading apparatus does not satisfy the sampling theorem in respect of the dot size (line width) of the read object. For example, it is an object of the present invention to provide technology capable of accurately determining change in the dot depositing positions even if the resolution of the recording elements is 1200 dpi (the pitch between recording elements is approximately 21 μm), the dot diameter is 40 to 50 μm, and the resolution of the reading apparatus in the main scanning direction is 500 dpi (the pitch of the read pixels is approximately 50 μm).

In order to attain an object described above, one aspect of the present invention is directed to a fine pattern position detection method comprising: a reading step of reading line patterns formed on a recording medium, at a prescribed read pixel pitch in a prescribed reading direction to acquire read data; a read pixel position acquisition step of acquiring from the read data corresponding positions of the line patterns based on the read pixel pitch; a characteristic value acquisition step of acquiring, from the read data, characteristic values at the corresponding positions of the line patterns and characteristic values at adjacent pixel positions which are adjacent to each of the corresponding positions of the line patterns according to the read pixel pitch; a candidate position output step of applying the characteristic values at the corresponding positions of the line patterns and the characteristic values at the adjacent pixel positions, to a position table in which the characteristic value at each of the corresponding positions of the line patterns and the characteristic values at the adjacent pixel positions are associated with a candidate position which is a candidate position having highest possibility of arrangement of each of the line patterns and which is assigned at a distance shorter than the read pixel pitch from the corresponding position of each of the line patterns, so as to output the candidate position of each of the line patterns; and a recording position acquisition step of calculating a recording position of each of the line patterns on the recording medium, from the corresponding position of each of the line patterns based on the read pixel pitch and the output candidate position of each of the line patterns.

According to this aspect of the invention, it is possible to identify accurately a position (candidate position) of a line pattern in units of smaller than the read pixel pitch from a characteristic value having a correlation with the line pattern, by referring to a position table.

In particular, since a position table is used, then the position of a line pattern in units smaller than the read pixel pitch can be determined, in a simple fashion, from multi-dimensional (a plurality of) input values (characteristic values).

A “characteristic value” referred to here is a value which reflects a correlation with a line pattern, and which represents an effect of a line pattern in each position based on the read pixel pitch (including the position corresponding to a line pattern and the adjacent pixel positions). An example of this characteristic value is the optical density (tone value), for instance.

Desirably, the candidate position each of the line patterns is separated from the corresponding position of each of the line patterns by a distance shorter than one pixel based on the read pixel pitch; and in the recording position acquisition step, the recording position of each of the line patterns in read pixel pitch units is determined from the corresponding position based on the read pixel pitch, and the recording position of each of the line patterns in units of less than one pixel based on the read pixel pitch is determined from the candidate position having the highest possibility of arrangement of each of the line patterns.

According to this aspect of the invention, it is possible to identify the position of a line pattern in units of less than one pixel, from candidate positions set in units of less than one pixel based on the read pixel pitch.

Desirably, the position table reflects: a conformance deduction step of deducing conformances which are prepared for a plurality of candidate positions respectively and each represent a possibility of arrangement of each of the line patterns, from the characteristic value at the corresponding position of each of the line patterns and the characteristic values at the adjacent pixel positions, according to conformance functions which relate to respective multi-dimensional input values, are prepared for the plurality of candidate values and associate the characteristic values with the conformances; and a candidate position acquisition step of detecting the candidate position displaying the best conformance, according to the conformances deduced for the plurality of candidate positions respectively, and in the candidate position output step, the characteristic value at the corresponding position of each of the line patterns and the characteristic value at the adjacent pixel positions are input to the position table as the multi-dimensional input values, and the candidate position displaying the best conformance is output.

According to this aspect of the invention, a candidate position displaying the best degree of conformance is output by the position table on the basis of the conformances of a plurality of candidate positions, and therefore it is possible to identify the position of a line pattern with good accuracy in units of less than one pixel.

Desirably, the line patterns formed on the recording medium each have a width substantially equal to the read pixel pitch in the reading direction.

Desirably, the line patterns formed on the recording medium each have a width of not more than five times the read pixel pitch in the reading direction.

Even in cases such as these, according to the aforementioned modes of the present invention, it is possible to identify the position of a line pattern with good accuracy in units of less than one pixel based on the read pixel pitch.

Desirably, the characteristic value at the corresponding position of each of the line patterns and the characteristic values at the adjacent pixel positions are calculated from the read data at the corresponding position of each of the line patterns and the read data at two adjacent pixel positions on a forward side and two adjacent pixel positions on a rearward side of the corresponding position of each of the line patterns in terms of the reading direction according to the read pixel pitch.

According to this aspect of the invention, the characteristic values are deduced synthetically from read data at a position corresponding to a line pattern and a total of four adjacent pixel positions, namely two each before and after same, and the position of a line pattern can be identified with good accuracy in units of less than one pixel based on the read pixel pitch.

Desirably, in the reading step, the read data relating to optical density is acquired; and the characteristic values are based on the optical density.

According to this aspect of the invention, it is possible to identify the position of a line pattern with good accuracy in units of less than one pixel based on the read pixel pitch, in a simple fashion, from read data relating to optical density.

Desirably, the characteristic values are based on a first differential value of the read data.

By using a first differential value of the read data in this way, there are cases where it is possible to use a value which more clearly reflects the characteristics of a line pattern, as a characteristic value.

Desirably, on the recording medium, a detection bar which has a prescribed width and extends continuously in the reading direction is formed so as to correspond to the line patterns; in the reading step, the line patterns and the detection bar are read simultaneously to acquire the read data relating to optical density; and in the read pixel position acquisition step, a position of the detection bar is determined from change in the optical density indicated by the read data, and the corresponding position of each of the line patterns is acquired from the determined position of the detection bar and a positional relationship between the detection bar and each of the line patterns.

According to this aspect of the invention, it is possible to identify the position of a line pattern accurately from a detection bar having a simple composition.

Desirably, the fine pattern position detection method further comprises a table correction step of correcting the position table according to the recording position of each of the line patterns calculated in the recording position acquisition step and position information including position data in read pixel pitch units and position data in units of less than one pixel based on the read pixel pitch of the line patterns.

According to this aspect of the invention, since the position table is corrected on the basis of position information on a line pattern, then the recording position of a line pattern can be identified more accurately and precisely.

Desirably, the position information includes the position data in the read pixel pitch units and the position data in units of less than one pixel based on the read pixel pitch of the line patterns, both the position data being obtained by reading the line patterns at a resolution based on a smaller pitch than the read pixel pitch.

According to this aspect of the invention, the position table is corrected on the basis of data having a high reading resolution which is read at a shorter pitch resolution than the read pixel pitch used when acquiring the read data, and therefore it is possible to correct the position table more accurately.

Desirably, the position information includes the position data in read pixel pitch units and the position data in units of less than one pixel based on the read pixel pitch of the line patterns, both the position data being acquired in advance in respect of the line patterns.

According to this aspect of the invention, since the position table is corrected on the basis of position information which is identified previously in respect of the line patterns, then it is possible to correct the position table appropriately. The position information “which is acquired previously in respect of the line patterns” is information relating to positions with the line patterns, and for example, position information obtained when reading and detection of line patterns are performed previously (in the previous time), or position information used to create line patterns, or the like, can be used for that.

In order to attain an object described above, another aspect of the present invention is directed to a defective nozzle detection method comprising: a fine pattern position detection method described above; a pattern forming step of ejecting liquid from nozzles to form the line patterns corresponding to the nozzles respectively, on the recording medium; and a defective nozzle detection step of detecting a defective ejection nozzle from among the nozzles, according to reference positions which form reference for depositing positions of the liquid on the recording medium and which are set for the nozzles respectively, and the recording position of each of the line patterns calculated in the recording position acquisition step.

According to this aspect of the invention, it is possible accurately to detect a defective ejection nozzle from line pattern positions and reference positions which are identified with good accuracy.

Desirably, the reference position for each of the nozzles is calculated according to the recording positions of the line patterns for adjacent nozzles to each of the nozzles.

According to this aspect of the invention, it is possible to determine reference positions used to detect a defective ejection nozzle, in a simple fashion.

In order to attain an object described above, another aspect of the present invention is directed to a liquid ejection method comprising: a defective nozzle detection method described above; a reception step of receiving input data; a correction step of correcting the received input data; and an ejection step of ejecting the liquid from the nozzles according to the corrected input data, wherein in the correction step, the input data is corrected in such a manner that ejection of the liquid from the defective ejection nozzle detected in the defective nozzle detection step is compensated by another nozzle and the liquid is not ejected from the defective ejection nozzle.

According to this aspect of the invention, it is possible to correct liquid ejection from an accurately detected defective ejection nozzle, in a more precise fashion, and liquid ejection which faithfully reflects the input data can be achieved.

In order to attain an object described above, another aspect of the present invention is directed to a fine pattern position detection apparatus comprising: a reading device which reads line patterns formed on a recording medium, at a prescribed read pixel pitch in a prescribed reading direction, to acquire read data; a read pixel position acquisition device which acquires, from the read data, corresponding positions of the line patterns based on the read pixel pitch; a characteristic value acquisition device which acquires, from the read data, a characteristic value at the corresponding position of each of the line patterns and characteristic values at adjacent pixel positions which are adjacent to the corresponding position of each of the line patterns according to the read pixel pitch; a candidate position output device in which the characteristic values at the corresponding positions of the line patterns and the characteristic values at the adjacent pixel positions are applied to a position table in which the characteristic value at each of the corresponding positions of the line patterns and the characteristic values at the adjacent pixel positions are associated with a candidate position which is a candidate position having the highest possibility of arrangement of each of the line patterns and which is assigned at a distance shorter than the read pixel pitch from the corresponding position of each of the line patterns, so as to output the candidate position of each of the line patterns; and a recording position acquisition device which calculates a recording position of each of the line patterns on the recording medium, from the corresponding position of each of the line patterns based on the read pixel pitch and the output candidate position of each of the line patterns.

In order to attain an object described above, another aspect of the present invention is directed to a defective nozzle detection apparatus comprising: a fine pattern position detection apparatus described above: a pattern forming device which eject liquid from nozzles to form the line patterns corresponding to the respective nozzles; and a defective nozzle detection device which detects a defective ejection nozzle from among the nozzles, according to reference positions which form reference for depositing positions of the liquid on the recording medium and which are set for the nozzles respectively, and the recording position of each of the line patterns calculated by the recording position acquisition device.

In order to attain an object described above, another aspect of the present invention is directed to a liquid ejection apparatus comprising: a defective nozzle detection apparatus described above; a reception device which receives input data; a correction device which corrects the received input data; and an ejection device which ejects the liquid from the nozzles according to the corrected input data, wherein the correction device corrects the input data in such a manner that ejection of the liquid from the defective ejection nozzle detected by the defective nozzle detection device is compensated by another nozzle and the liquid is not ejected from the defective ejection nozzle.

According to the present invention, it is possible accurately to identify a position (candidate position) of a line pattern in units of less than the read pixel pitch, by means of a position table which is associated with multi-dimensional (a plurality of) input values (characteristic values).

### BRIEF DESCRIPTION OF THE DRAWINGS

A preferred embodiment of this invention as well as other objects and benefits thereof, will be explained in the following with reference to the accompanying drawings, in which like reference characters designate the same or similar parts throughout the figures and wherein:

FIG. 1 is a general schematic drawing of an inkjet recording apparatus relating to one embodiment of the present invention;

FIG. 2A is a plan view perspective diagram illustrating an example of the structure of a head 50, and FIG. 2B is a partial enlarged diagram of FIG. 2A;

FIG. 3 is a plan view perspective diagram showing an example of the structure of a head;

FIG. 4 is a cross-sectional diagram along line 4-4 in FIGS. 2A and 2B;

FIG. 5 is an enlarged diagram showing a nozzle arrangement in a head;

FIG. 6 is a block diagram showing the system composition of an inkjet recording apparatus;

FIGS. 7A to 7C show schematic views of a state where the depositing positions on a recording medium of the ink droplets ejected from the nozzles have deviated from the ideal depositing positions, in which FIG. 7A is a plan diagram showing a line arrangement of a plurality of nozzles in a head, FIG. 7B is a diagram of a state of ejecting ink droplets from nozzles toward recording paper, as viewed in a horizontal direction, and FIG. 7C is a plan view of test patterns (depositing positions) formed on recording paper by ink droplets ejected from nozzles;

FIG. 8 is a flowchart showing one example of a process for detecting defective recording elements (defective ejection nozzles);

FIG. 9 is a functional block diagram of a system relating to processing for detection of defective ejection nozzles and correction of input image data;

FIG. 10 is a diagram showing the basic shape of test patterns recorded on recording paper;

FIG. 11 is a diagram showing one specific example of test patterns, and depicts test patterns including reference position detection bars;

FIG. 12 is a conceptual diagram of a read image of test patterns when the reading resolution of the printing apparatus is 1200 dpi;

FIG. 13 is a conceptual diagram of a read image of test patterns when the reading resolution of the printing apparatus is 500 dpi;

FIG. 14 is a flowchart showing a sequence for determining positional error of each line position of a test pattern;

FIG. 15 is a diagram describing a method of determining reference positions for identifying line positions from a read image;

FIG. 16 is a diagram showing the clipping of line blocks of nozzles on the basis of reference positions;

FIG. 17 is a diagram showing one example of test patterns where analysis regions are partially overlapped;

FIG. 18 is a diagram showing a graph of a binarized density distribution profile in each line block;

FIG. 19 is a flowchart showing a process of calculating a position in sub-pixel units for each line position of a test pattern;

FIG. 20A is a table showing the relationship between a conformance function table for specifying a line position at the sub-pixel level and a position in sub-pixel units, and FIG. 20B shows a schematic view of the relationship between pixel positions on a read image and candidate positions;

FIG. 21 is a graph showing a basic shape (basic concept) of a conformance function table, in which the X axis indicates an input value and the Y axis indicates a degree of conformance;

FIG. 22 is a graph showing a plurality of conformance function characteristics for specifying a position in units of less than one pixel, which corresponds to an initial first differential value tz1;

FIG. 23 is a graph showing a plurality of conformance function characteristics for specifying a position in units of less than one pixel, which corresponds to a second first differential value tz2;

FIG. 24 is a graph showing a plurality of conformance function characteristics for specifying a position in units of less than one pixel, which corresponds to a third first differential value tz3;

FIG. 25 is a graph showing a plurality of conformance function characteristics for specifying a position in units of less than one pixel, which corresponds to a fourth first differential value tz4;

FIG. 26 is a diagram showing a schematic view of a method of calculating a relative position of a test pattern on a read image;

FIG. 27 is a diagram showing one example of a method of calculating the reference position and illustrates a method of calculating a reference position from the positions of the adjacent lines (test patterns) on either side;

FIG. 28 is a diagram showing another example of a method of calculating the reference position and illustrates a method of calculating a reference position from the positions of the adjacent lines (test patterns) on one side;

FIG. 29 is a flowchart showing an overall flow of image printing;

FIG. 30 is a flowchart showing an overall flow of defective ejection nozzle detection;

FIG. 31 is a flowchart showing one example of an algorithm for detecting a position of a test pattern in sub-pixel units which are smaller than the reading resolution (reading pixel pitch);

FIG. 32 is a functional block diagram showing the functional composition of a defective ejection nozzle detection unit which processes the algorithm in FIG. 31;

FIG. 33 is a layout diagram on printing paper in a system which detects and corrects defective ejection nozzles;

FIG. 34 is a block diagram showing a flow for calculating a position of a test pattern in units of less than one pixel;

FIG. 35 is a flowchart showing a process for creating a multi-dimensional table;

FIG. 36 is a functional block diagram relating to a process for creating a multi-dimensional table;

FIG. 37 is a flowchart showing pattern position detection by a target reading apparatus;

FIG. 38 is a flowchart showing pattern position detection by a reference reading apparatus;

FIGS. 39A and 39B are diagrams for illustrating the matching of the reading conditions by a target reading apparatus and the reading conditions by a reference reading apparatus, where FIG. 39A shows a profile from the reference reading apparatus, and FIG. 39B shows a profile from the target reading apparatus;

FIG. 40 is a flowchart showing a flow for creating a multi-dimensional table without using a reference reading apparatus;

FIG. 41 is a diagram showing a profile of a case where the reading pixel pitch is far from the read object pitch (where the read pixel pitch is fine) (2400 dpi);

FIG. 42 is a diagram showing a profile of a case where the reading pixel pitch is close to the read object pitch (500 dpi); and

FIG. 43 is a diagram showing a profile where the reading pixel pitch is close to the read object pitch (500 dpi) and a profile where the reading pixel pitch is far from the read object pitch (where the reading pixel pitch is fine) (2400 dpi).

### DESCRIPTION OF THE PREFERRED EMBODIMENTS

Here, an example of application to measurement of the depositing positions of ink dots (in other words, dot positions) by an image forming apparatus (inkjet recording apparatus) will be described. Firstly, the overall composition of an inkjet recording apparatus will be described.

### Inkjet Recording Apparatus

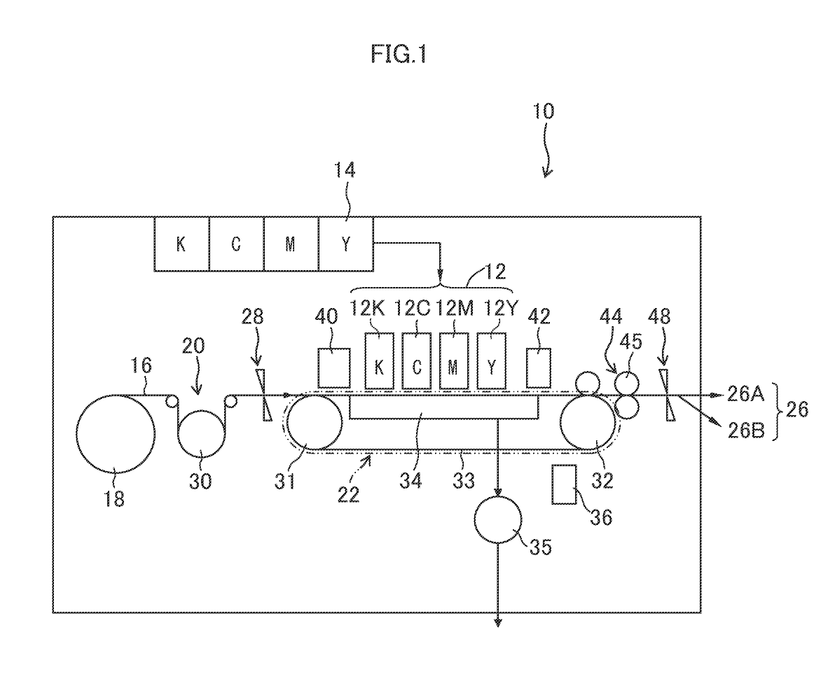

FIG. 1 is a general schematic drawing of an inkjet recording apparatus relating to one embodiment of the present invention;

As shown in FIG. 1, the inkjet recording apparatus 10 comprises: a printing unit 12 having a plurality of inkjet recording heads (corresponding to “liquid ejection heads” and hereafter, called “heads”) 12K, 12C, 12M, and 12Y provided for ink colors of black (K), cyan

(C), magenta (M), and yellow (Y), respectively; an ink storing and loading unit 14 for storing inks of K, C, M and Y to be supplied to the printing heads 12K, 12C, 12M, and 12Y; a paper supply unit 18 for supplying recording paper 16 which is a recording medium; a decurling unit 20 removing curl in the recording paper 16; a belt conveyance unit 22 disposed facing the nozzle face (ink-droplet ejection face) of the printing unit 12, for conveying the recording paper 16 while keeping the recording paper 16 flat; and a paper output unit 26 for outputting image-printed recording paper (printed matter) to the exterior.

The ink storing and loading unit 14 has ink tanks for storing the inks of K, C, M and Y to be supplied to the heads 12K, 12C, 12M, and 12Y, and the tanks are respectively connected to the heads 12K, 12C, 12M, and 12Y by means of prescribed channels.

In FIG. 1, a magazine for rolled paper (continuous paper) is shown as an example of the paper supply unit 18; however, more magazines with paper differences such as paper width and quality may be jointly provided. Moreover, papers may be supplied with cassettes that contain cut papers loaded in layers and that are used jointly or in lieu of the magazine for rolled paper.

If the apparatus is composed so as to be able to use recording media of a plurality of different types, then desirably, a device for identifying the type of recording medium (media type) used is provided and ink ejection is controlled so as to achieve suitable ink ejection in accordance with the media type.

The recording paper 16 delivered from the paper supply unit 18 retains curl due to having been loaded in the magazine. In order to remove the curl, heat is applied to the recording paper 16 in the decurling unit 20 by a heating drum 30 in the direction opposite from the curl direction in the magazine. The heating temperature at this time is desirably controlled so that the recording paper 16 has a curl in which the surface on which the print is to be made is slightly round outward.

The recording paper 16 decurled and then cut into a desired size by a cutter (a first cutter) 28 is delivered to the belt conveyance unit 22. The suction belt conveyance unit 22 has a configuration in which an endless belt 33 is set around rollers 31 and 32 so that the portion of the endless belt 33 facing at least the nozzle face of the printing unit 12 forms a horizontal plane (flat plane).

The belt 33 has a width that is greater than the width of the recording paper 16, and a lot of suction apertures (not shown) are formed on the belt surface. A suction chamber 34 is disposed in a position facing the nozzle surface of the printing unit 12 on the interior side of the belt 33, which is set around the rollers 31 and 32. The suction chamber 34 provides suction with a fan 35 to generate a negative pressure, and the recording paper 16 is held on the belt 33 by suction. Moreover, in place of the suction system, the electrostatic attraction system may be employed.

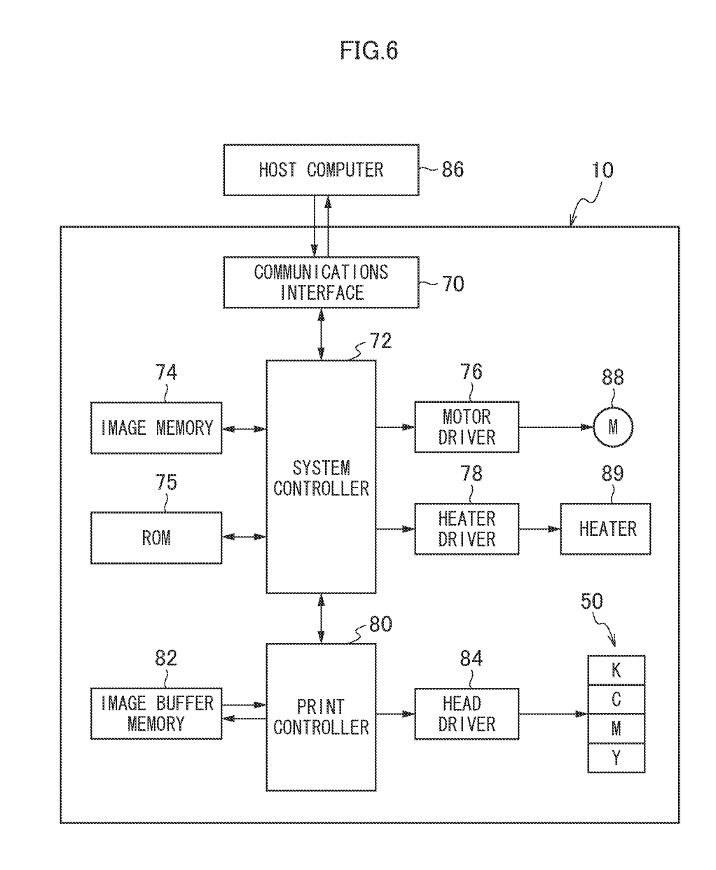

The belt 33 is driven in the clockwise direction in FIG. 1 by the motive force of a motor (shown by reference numeral 88 in FIG. 6) being transmitted to at least one of the rollers 31 and 32, and the recording paper 16 held on the belt 33 is conveyed from left to right in FIG. 1.

A belt-cleaning unit 36 is disposed in a predetermined position (a suitable position outside the printing area) on the exterior side of the belt 33. Although the detailed configuration of the belt-cleaning unit 36 is not shown, examples thereof include a configuration in which the belt 33 is nipped with cleaning rollers such as a brush roller and a water absorbent roller, an air blow configuration in which clean air is blown onto the belt 33, or a combination of these.

A heating fan 40 is disposed on the upstream side of the printing unit 12 in the conveyance pathway formed by the belt conveyance unit 22. The heating fan 40 blows heated air onto the recording paper 16 to heat the recording paper 16 immediately before printing so that the ink deposited on the recording paper 16 dries more easily.

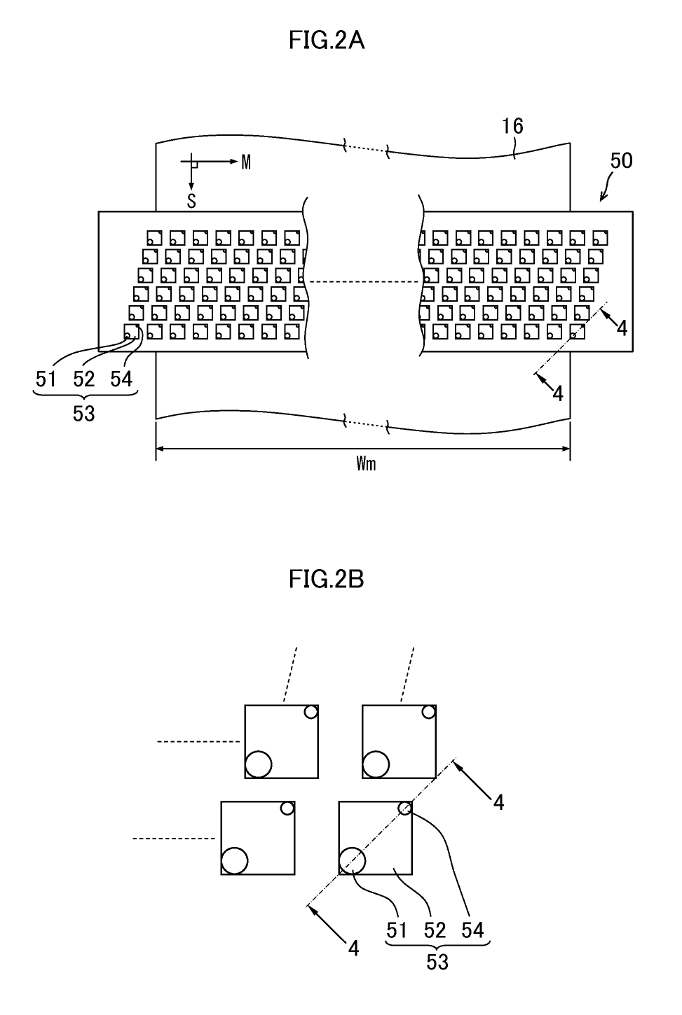

The heads 12K, 12C, 12M and 12Y of the printing unit 12 are full line heads having a length corresponding to the maximum width of the recording paper 16 used with the inkjet recording apparatus 10, and comprising a plurality of nozzles for ejecting ink arranged on a nozzle face through a length exceeding at least one edge of the maximum-size recording medium (namely, the full width of the printable range) (see FIG. 2A and FIG. 2B).

The printing heads 12K, 12C, 12M and 12Y are arranged in color order (black (K), cyan (C), magenta (M), yellow (Y)) from the upstream side in the feed direction of the recording paper 16, and these heads 12K, 12C, 12M and 12Y are each provided extending in a direction substantially perpendicular to the conveyance direction of the recording paper 16.

A color image can be formed on the recording paper 16 by ejecting inks of different colors from the heads 12K, 12C, 12M and 12Y, respectively, onto the recording paper 16 while the recording paper 16 is conveyed by the belt conveyance unit 22.

In this way, according to a composition where full line type heads 12K, 12C, 12M and 12Y having nozzle rows covering the whole of the paper width are provided respectively for the colors, it is possible to record an image over the whole surface of recording paper 16 by performing just one operation of moving the recording paper 16 and the print unit 12 relatively in the paper feed direction (the sub-scanning direction), (in other words, by means of one sub-scanning action). Forming an image by a single pass method using a full line type (page-wide) head of this kind enables high-speed printing compared to a case of using a multiple-pass method employing a serial (shuttle) type head which moves back and forth in a direction (the main scanning direction) which is perpendicular to the conveyance direction of the recording medium (the sub-scanning direction), and therefore printing productivity can be improved.

Although the configuration with the KCMY four standard colors is described in the present embodiment, combinations of the ink colors and the number of colors are not limited to the configuration of the present embodiment. Light inks, dark inks or special color inks can be added as required. For example, a configuration is possible in which inkjet heads for ejecting light-colored inks such as light cyan and light magenta are added. Furthermore, there are no particular restrictions of the sequence in which the heads of respective colors are arranged.

A post-drying unit 42 is disposed following the print unit 12. The post-drying unit 42 is a device to dry the printed image surface, and includes a heating fan, for example. It is desirable to avoid contact with the printed surface until the printed ink dries, and a device that blows heated air onto the printed surface is desirable.

A heating/pressurizing unit 44 is disposed following the post-drying unit 42. The heating/pressurizing unit 44 is a device to control the glossiness of the image surface, and the image surface is pressed with a pressure roller 45 having a predetermined uneven surface shape while the image surface is heated, and the uneven shape is transferred to the image surface.

The printed matter generated in this manner is outputted from the paper output unit 26. The target print (i.e., the result of printing the target image) and the test print are desirably outputted separately. In the inkjet recording apparatus 10, a sorting device (not shown) is provided for switching the outputting pathways in order to sort the printed matter with the target print and the printed matter with the test print, and to send them to paper output units 26A and 26B, respectively. When the target print and the test print are simultaneously formed in parallel on the same large sheet of paper, the test print portion is cut and separated by a cutter (second cutter) 48.

Furthermore, although not shown in FIG. 1, a sorter which stacks images for different orders is provided in the output unit 26A for the main images. Apart from this, the inkjet recording apparatus 10 according to the present embodiment also includes a head maintenance unit which performs cleaning (nozzle surface wiping, purging, nozzle suctioning, etc.) of the heads 12K, 12C, 12M and 12Y, a sensor for determining the position of the recording paper 16 on the paper conveyance path, and the like, and a temperature sensor for determining the temperature of the respective units of the apparatus, and so on.

### Structure of the Head

Next, the structure of a head will be described. The heads 12K, 12C, 12M and 12Y of the respective ink colors have the same structure, and a reference numeral 50 is hereinafter designated to any of the heads.

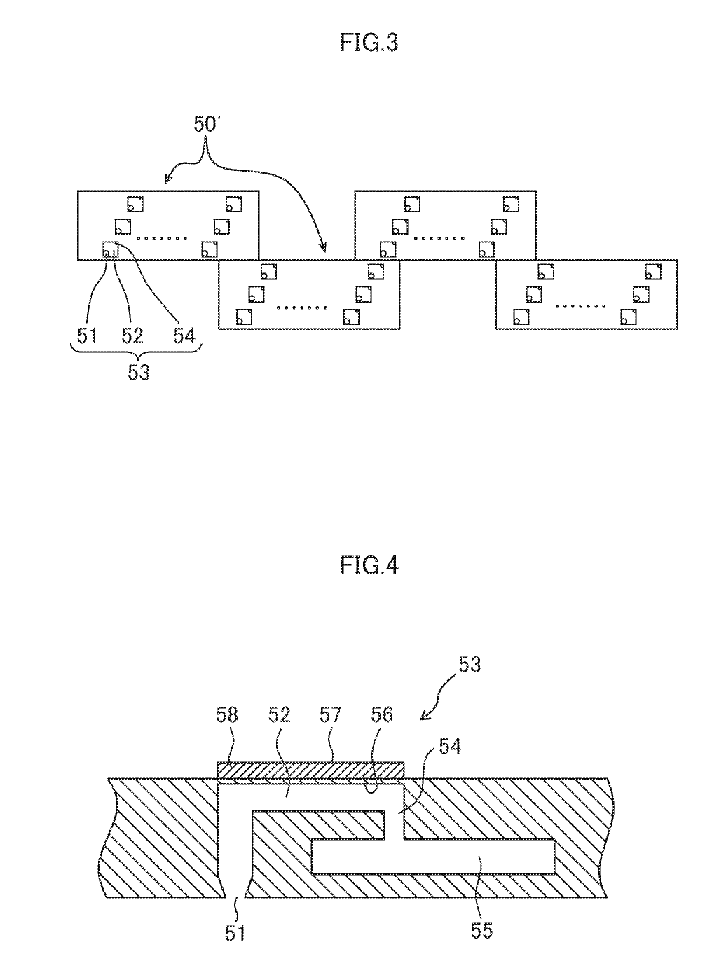

FIG. 2A is a perspective plan view showing an example of the configuration of the head 50, FIG. 2B is an enlarged view of a portion thereof, FIG. 3 is a perspective plan view showing another example of the configuration of the head 50, and FIG. 4 is a cross-sectional view taken along the line 4-4 in FIGS. 2A and 2B, showing the inner structure of a droplet ejection element (an ink chamber unit for one nozzle 51).

As shown in FIGS. 2A and 2B, the head 50 according to the present embodiment has a structure in which a plurality of ink chamber units (droplet ejection elements) 53, each comprising a nozzle 51 forming an ink ejection port, a pressure chamber 52 corresponding to the nozzle 51, and the like, are disposed two-dimensionally in the form of a staggered matrix, and hence the effective nozzle interval (the projected nozzle pitch) as projected (orthogonal projection) in the lengthwise direction of the head (the direction perpendicular to the paper conveyance direction) is reduced and high nozzle density is achieved.

The mode of forming one or more nozzle rows with not less than a length corresponding to the entire width Wm of the recording paper 16 in a direction (direction indicated by arrow M; main scanning direction) substantially perpendicular to the conveyance direction (direction indicated by arrow S; sub scanning direction) of the recording paper 16 is not limited to the example described above. For example, instead of the configuration in FIG. 2A, as shown in FIG. 3, a line head having nozzle rows of a length corresponding to the entire width of the recording paper 16 can be formed by arranging and combining, in a staggered matrix, short head modules 50′ having a plurality of nozzles 51 arrayed in a two-dimensional fashion.

The pressure chambers 52 provided to correspond to the respective nozzles 51 have a substantially square planar shape (see FIG. 2A and FIG. 2B), an outlet port to the nozzle 51 being provided in one corner of a diagonal of each pressure chamber, and an ink inlet port (supply port) 54 being provided in the other corner thereof. The shape of the pressure chamber 52 is not limited to that of the present example and various modes are possible in which the planar shape is a quadrilateral shape (diamond shape, rectangular shape, or the like), a pentagonal shape, a hexagonal shape, or other polygonal shape, or a circular shape, elliptical shape, or the like.

As shown in FIG. 4, each pressure chamber 52 is connected to a common channel 55 through the supply port 54. The common channel 55 is connected to an ink tank (not illustrated), which is a base tank that supplies ink, and the ink supplied from the ink tank is delivered through the common flow channel 55 to the pressure chambers 52.

Actuators 58 provided with individual electrodes 57 respectively are bonded to a pressure plate (a diaphragm that also serves as a common electrode) 56 which forms the surface of one portion (in FIG. 4, the ceiling) of the pressure chambers 52. When a drive voltage is applied between the individual electrode 57 and the common electrode 56, the actuator 58 deforms, thereby changing the volume of the pressure chamber 52. This causes a pressure change which results in ink being ejected from the nozzle 51. For the actuators 58, it is suitable to use a piezoelectric element employing a piezoelectric body such as lead zirconate titanate or barium titanate. When the actuator 58 returns to its original position after ejecting ink, the pressure chamber 52 is replenished with new ink from the common flow channel 55 via the supply port 54.

It is possible to eject ink droplets from the nozzles 51 by controlling the driving of the actuators 58 corresponding to the nozzles 51 in accordance with the dot arrangement data generated from the input image. It is possible to record a desired image on the recording paper 16 by controlling the ink ejection timing of the nozzles 51 in accordance with the conveyance speed of the paper, while conveying the recording paper 16 in the sub-scanning direction at a uniform speed.

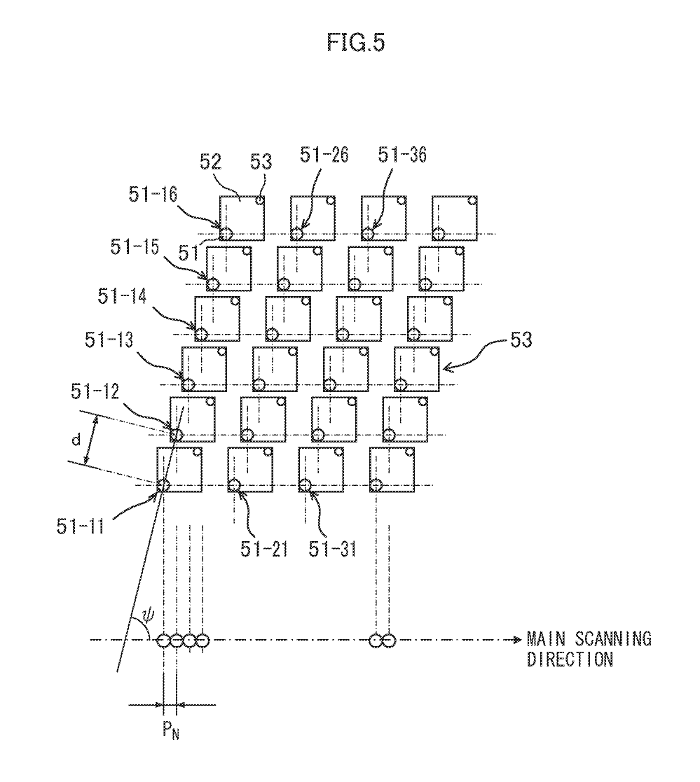

As shown in FIG. 5, the high-density nozzle head is achieved by arranging obliquely a plurality of ink chamber units 53 having the above-described structure in a lattice fashion based on a fixed arrangement pattern, in a row direction which coincides with the main scanning direction, and a column direction which is inclined at a fixed angle of w with respect to the main scanning direction, rather than being perpendicular to the main scanning direction. In other words, by adopting a structure in which a plurality of ink chamber units 53 are arranged at a uniform pitch d in a direction forming an angle yr with respect to the main scanning direction, it is possible to treat the nozzles 51 effectively as being equivalent to a linear arrangement of nozzles 51 at a uniform pitch of PN=d×cosΨ.

When the nozzles 51 arranged in a matrix configuration as shown in FIG. 5 are driven, the nozzles 51-11, 51-12, 51-13, 51-14, 51-15, 51-16 are taken as one block (and furthermore, the nozzles 51-21, . . . , 51-26 are taken as one block, the nozzles 51-31, . . . , 51-36 are taken as one block, and so on), and by driving the nozzles sequentially from one end to the other end in each respective block (in the sequence: nozzle 51-11, 51-12, . . . , 51-16), in accordance with the conveyance speed of the recording paper 16, one line (a line constituted by one row of dots or a line constituted by a plurality of rows of dots) is printed in the width direction of the recording paper 16 (the direction perpendicular to the paper conveyance direction).

The main scanning direction is the direction of one line recorded by this nozzle driving (main scanning) (or the lengthwise direction of a band-shaped region), and the sub-scanning direction is the direction in which printing of one line formed by this main scanning (a line formed by one row of dots or a line formed by a plurality of rows of dots) is repeated in the direction of relative movement by relative movement of the head and the recording paper 16. In other words, in the present embodiment, the conveyance direction of the recording paper 16 is the sub-scanning direction, and direction perpendicular to this is the main scanning direction.

In the present embodiment, piezoelectric elements are employed as ejection force generating devices for ink ejected from nozzles 51 provided in a head 50, but the device for generating ejection pressure (ejection energy) is not limited to a piezoelectric element, and various devices and methods, such as heaters (heating elements) based on a thermal method or various actuators based on other methods can be applied.

Furthermore, in implementing the present embodiment, the mode of arrangement of the nozzles 51 in the head 50 is not limited to the example shown in the drawings, and it is possible to adopt various nozzle arrangements. For example, instead of the matrix arrangement shown in FIG. 2A and FIG. 2B, it is possible to use a single row linear arrangement, or a bent line-shaped nozzle arrangement, such as a V-shaped nozzle arrangement, or a zigzag shape (W shape, or the like) such as a shape in which a V-shaped nozzle arrangement is repeated.

### Description of Control System

FIG. 6 is a block diagram showing the system configuration of the inkjet recording apparatus 10.

As shown in FIG. 6, the inkjet recording apparatus 10 comprises a communication interface 70, a system controller 72, an image memory 74, a ROM 75, a motor driver 76, a heater driver 78, a print controller 80, an image buffer memory 82, and a head driver 84. The communication interface 70 is an interface unit (an image input unit) for receiving image data sent from a host computer 86. A serial interface such as USB (Universal Serial Bus), 1EEE1394, Ethernet (registered trademark), wireless network, or a parallel interface such as a Centronics interface may be used as the communication interface 70. A buffer memory (not shown) may be mounted in this portion in order to increase the communication speed.

The image data sent from the host computer 86 is received by the inkjet recording apparatus 10 through the communication interface 70, and is temporarily stored in the image memory 74. The image memory 74 is a storage device for storing images inputted through the communication interface 70, and data is written and read to and from the image memory 74 through the system controller 72. The image memory 74 is not limited to a memory composed of semiconductor elements, and a hard disk drive or another magnetic medium may be used.

The system controller 72 is constituted by a central processing unit (CPU) and peripheral circuits thereof, and the like, and it functions as a control device for controlling the whole of the inkjet recording apparatus 10 in accordance with a prescribed program, as well as a calculation device for performing various calculations. More specifically, the system controller 72 controls the various sections, such as the communication interface 70, image memory 74, motor driver 76, heater driver 78, and the like, as well as controlling communications with the host computer 86 and writing and reading to and from the image memory 74 and the ROM 75, and it also generates control signals for controlling the motor 88 of the conveyance system and the heater 89.

Programs executed by the CPU of the system controller 72 and the various types of data which are required for control procedures are stored in the ROM 75. The ROM 75 may be a non-writeable storage device, or it may be a rewriteable storage device, such as an EEPROM. The image memory 74 is used as a temporary storage region for the image data, and it is also used as a program development region and a calculation work region for the CPU.

The motor driver 76 is a driver (drive circuit) that drives the conveyance motor 88 in accordance with commands from the system controller 72. The heater driver (drive circuit) 78 drives the heater 89 of the post-drying unit 42 or the like in accordance with commands from the system controller 72.

The print controller 80 has a signal processing function for performing various tasks, compensations, and other types of processing for generating print control signals from the image data (original image data) stored in the image memory 74 in accordance with commands from the system controller 72 so as to supply the generated print data (dot data) to the head driver 84.

The print controller 80 is provided with the image buffer memory 82; and image data, parameters, and other data are temporarily stored in the image buffer memory 82 when image data is processed in the print controller 80. The aspect shown in FIG. 6 is one in which the image buffer memory 82 accompanies the print controller 80; however, the image memory 74 may also serve as the image buffer memory 82. Also possible is an aspect in which the print controller 80 and the system controller 72 are integrated to form a single processor.

To give a general description of the processing from image input until print output, the image data that is to be printed is input via the communications interface 70 from an external source and is collected in the image memory 74. At this stage, for example, RGB image data is stored in the image memory 74.

In the inkjet recording apparatus 10, an image having tones which appear continuous to the human eye is formed by altering the droplet ejection density and dot size of fine dots of ink (coloring material), and therefore it is necessary to convert the tones of the input digital image (light/dark density of the image) into a dot pattern which reproduces the tones as faithfully as possible. Consequently, data of the original image (RGB) accumulated in the image memory 74 is sent to the print controller 80 via the system controller 72, and is converted into dot data for each ink color by a half-toning process using a threshold value matrix, error diffusion, or the like, in the print controller 80.

In other words, the print controller 80 carries out processing for converting the input RGB image data into dot data for the four colors of K, C, M and Y. In this way, dot data generated by the print controller 80 is stored in the image buffer memory 82.

The head driver 84 outputs drive signals for driving the actuators 58 corresponding to the respective nozzles 51 of the head 50 on the basis of the print data supplied from the print controller 80 (in other words, dot data stored in the image buffer memory 82). The head driver 84 may also incorporate a feedback control system for maintaining uniform drive conditions in the heads.

By supplying the drive control signals output by the head driver 84 to the head 50, ink is ejected from nozzles 51. By controlling ink ejection from the heads 50 in synchronization with the conveyance velocity of the recording paper 16, an image is formed on the recording paper 16.

As described above, the ink droplet ejection volume and the ejection timing from the respective nozzles are controlled via the head driver 84 on the basis of the dot data generated by required signal processing in the print controller 80. By this means, a desired dot size and a dot arrangement are achieved.

Furthermore, the print controller 80 performs various corrections with respect to the head 50 on the basis of information about the dot positions obtained by the dot position measurement method described above, and the like, as well as implementing control so as to perform cleaning operations (nozzle restoring operations), such as preliminary ejection, nozzle suctioning, wiping, or the like, in accordance with requirements.

### Description of Dot Position Measurement Method

Next, the dot position measurement method relating to the present embodiment is described in detail.

### General Flow of Image Correction

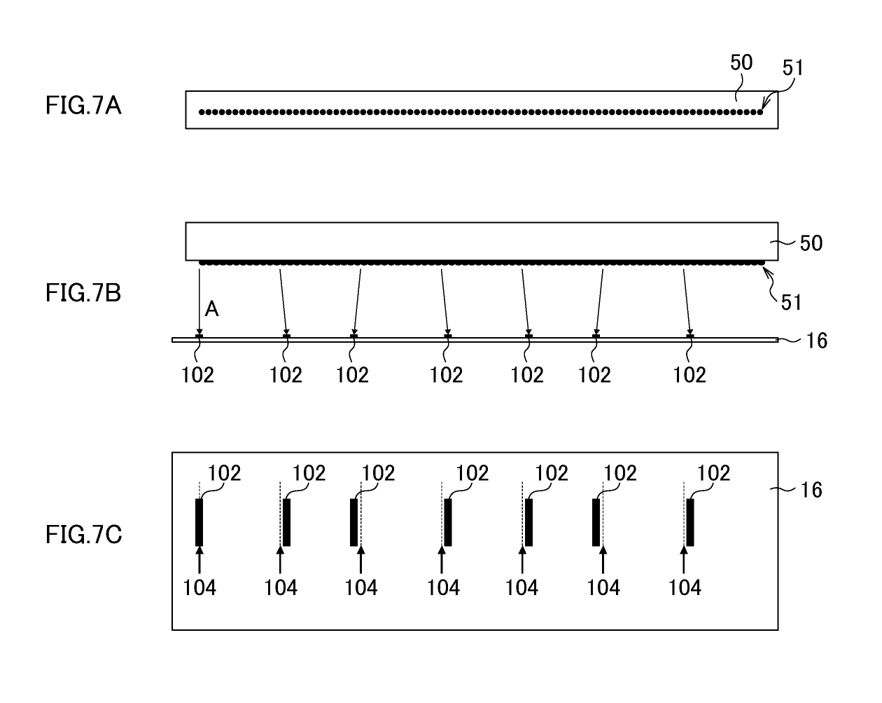

FIGS. 7A to 7C are diagrams showing schematic views of a state where the depositing positions on a recording medium of ink droplets ejected from nozzles have deviated from the ideal depositing positions. More specifically, FIG. 7A is a plan diagram showing a line arrangement of a plurality of nozzles 51 in a head 50. FIG. 7B is a diagram showing a lateral view of a state where ink droplets are ejected from nozzles 51 toward recording paper (a recording medium) 16, and an approximate view of the ejection direction of the ink droplets from the nozzles 51 is depicted by arrows A in FIG. 7B. FIG. 7C is a plan diagram showing test patterns (depositing positions) 102 formed on recording paper 16 by ink droplets ejected from nozzles 51, the ideal depositing positions 104 being depicted by the dotted lines and the actual depositing positions 102 being depicted by thick black lines.

In FIG. 7A and FIG. 7B, in order to simplify the drawings, a head 50 in which a plurality of nozzles 51 are aligned in one row is depicted, but as described in relation to FIG. 2A and FIG. 2B to FIG. 5, the invention can of course also be applied to a matrix head in which a plurality of nozzles are arranged in a two-dimensional configuration. In other words, by taking account of the effective nozzle row obtained by projecting a nozzle group in a two-dimensional arrangement to a straight line in the main scanning direction, it is possible to treat the nozzle configuration effectively as being equivalent to a single nozzle row.

As shown in FIG. 7A to FIG. 7C, the plurality of nozzles 51 in the head 50 include normal nozzles which display normal ejection characteristics and defective ejection nozzles of which the path of flight of the ejected ink droplets diverges excessively from the intended path. The line-shape dot patterns (test patterns) 102 formed by the ink droplets ejected from the defective ejection nozzles and deposited on the recording paper 16 deviate from the ideal depositing positions 104, and thus cause deterioration in image quality.

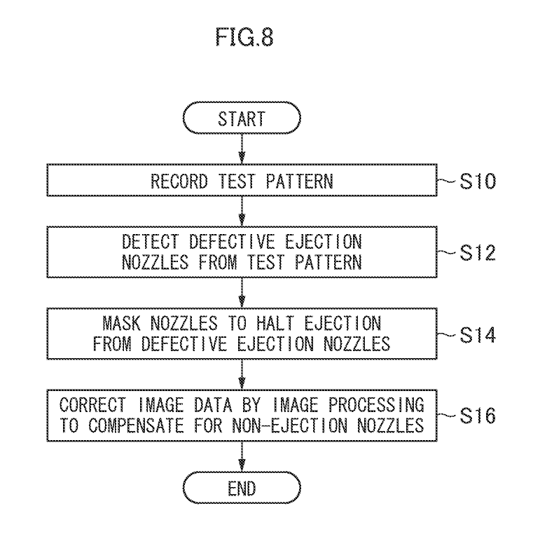

In a single-pass recording method, which is a high-speed recording technology, the number of nozzles corresponding to the width of the recording paper 16 is several tens of thousands per inch, and in the case of full-color recording, recording elements are also provided for each of the ink colors (for example, for the four colors of cyan, magenta, yellow and black). In a single-pass recording method of this kind, the process shown in FIG. 8 is one possible example of a method of detecting defective recording elements (defective ejection nozzles) from the several tens of thousands of recording elements.

Specifically, in order to detect variation in the ejection direction among the nozzles, as shown in FIG. 7A to FIG. 7C, ink droplets are ejected from the nozzles 51 toward the recording paper 16 to print test patterns 102 on the recording paper 16 (S10 in FIG. 8).

These test patterns 102 are read in by a low-resolution scanner, and the depositing position error of the test patterns 102 with respect to the ideal depositing positions 104 is determined by comparing the image data of the test patterns 102 thus read with prescribed values, in accordance with a prescribed detection algorithm. In this case, the nozzles which have excessive positional error greater than a prescribed value are detected and identified as defection ejection nozzles (S12). A specific sequence of the detection of a defective ejection nozzle is described below.

A defective ejection nozzle identified in this way is masked and treated as a non-ejecting nozzle which does not eject an ink droplet (S14). The input image data is corrected by image processing which takes account of compensating for ink droplets which are not ejected from non-ejecting nozzles, by means of ink droplets ejected from other ejection nozzles (for example, adjacent nozzles) (S16), and a desired image is recorded with good quality on the recording paper 16 on the basis of this corrected input image data.

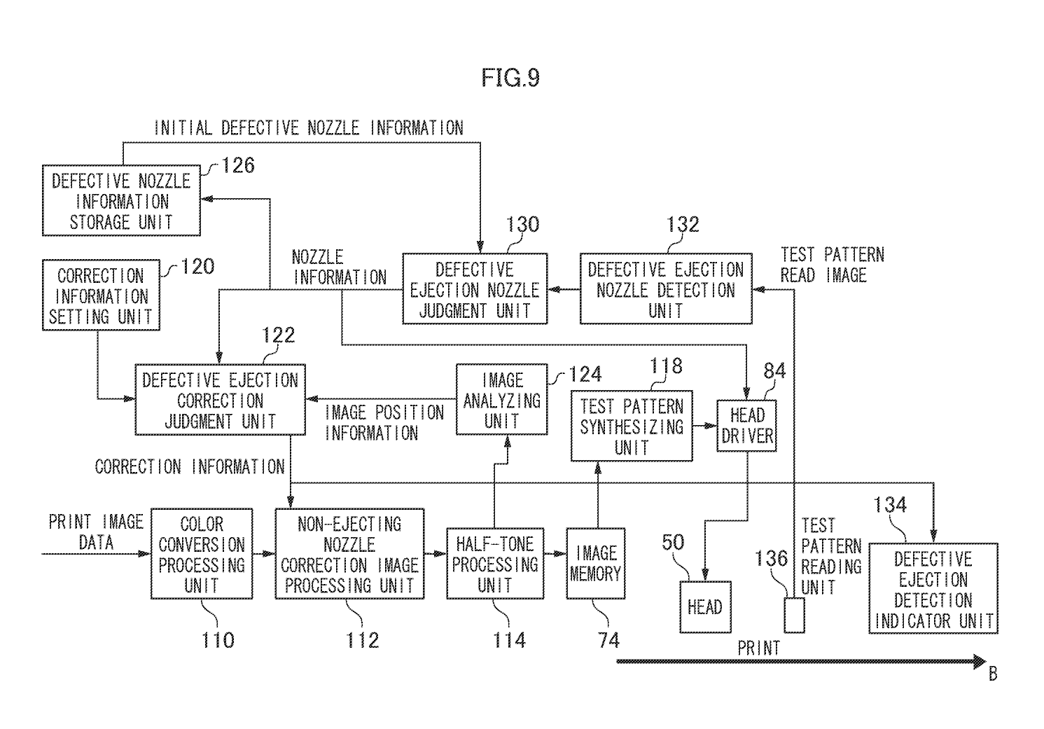

Next, a series of processing flows including detection of defective ejection nozzles and correction of input image data will be described. FIG. 9 is a functional block diagram of a system relating to processing for detection of defective ejection nozzles and correction of input image data.

The following units which are described below and illustrated in FIG. 9, namely, the color conversion processing unit 110, non-ejecting nozzle correction image processing unit 112, half-tone processing unit 114, image memory 74, image analyzing unit 124, test pattern synthesizing unit 118, head driver 84, defective ejection nozzle detection unit 132, defective ejection nozzle judgment unit 130, defective nozzle information storage unit 126, defective ejection correction judgment unit 122 and correction information setting unit 120, are constituted by one or a plurality of the respective control units of the inkjet recording apparatus 10.

The print image data to be printed which is supplied from a host computer via a communications interface is subjected to prescribed color conversion processing in the color conversion processing unit 110, and image data for respective plates corresponding to the recording inks (C, M, Y and K inks in the present embodiment) is obtained. The image data obtained in this way is sent from the color conversion processing unit 110 to the non-ejecting nozzle correction image processing unit 112.

On the other hand, in the defective ejection correction judgment unit 122, all defective nozzle correction information is comprehensively gathered, and corrected image positions which are the positions on the image where dots are to be recorded originally by the defective ejection nozzles, are identified from the correspondence between the image positions (image dot positions) and the nozzle positions. If the image portion in a corrected image position cannot be recorded suitably by a defective ejection nozzle, then in the defective ejection nozzle judgment unit 122, the recording information for the portion of the corrected image position corresponding to that defective ejection nozzle is allocated to one or a plurality of adjacent nozzles which are functioning normally and include nozzles on either side of the defective ejection nozzle. The allocation of recording information corresponding to a defective ejection nozzle referred to here means data processing (correction processing) for causing ink to be ejected from another nozzle in such a manner that the recording of a portion of a corrected image position corresponding to a defective ejection nozzle is compensated by ejection of ink from another nozzle. Moreover, the defective ejection correction judgment unit 122 corrects the image information allocated in this way, in accordance with the recording characteristics.

The defective ejection correction judgment unit 122 compares information from the image analyzing unit 124 (image position information data) and defective ejection nozzle information from the defective ejection nozzle judgment unit 130 to create correction information only for the image portion to be recorded by a defective ejection nozzle. In this step, the defective ejection correction judgment unit 122 is able to create correction information only in respect of a region where there is a high requirement for correction, more powerfully, by referring to data indicating the requirement for correction which is provided by the correction information setting unit 120 (for example, data indicating a correction region set on the print image, or data indicating a correction region (nozzle unit) set in the print unit of the head 50). The correction information created in this way is supplied from the defective ejection correction judgment unit 122 to the non-ejecting nozzle correction image processing unit 112.

In the non-ejecting nozzle correction image processing unit 112, correction processing is performed on the image data supplied from the color conversion processing unit 110, on the basis of the correction information relating to the defective ejection nozzle supplied from the defective ejection correction judgment unit 122. The image data after correction processing which reflects information on non-ejection from defective ejection nozzles in this way is supplied from the non-ejecting nozzle correction image processing unit 112 to the half-tone processing unit 114.

In the half-tone processing unit 114, half-tone processing is carried out on the image data supplied from the non-ejecting nozzle correction image processing unit 112, thereby generating multiple-value image data for driving the recording head 50. In this step, half-tone processing is performed in such a manner that the multiple-value image data thus generated (the multiple values for driving the recording head) is smaller than the number of graduated tones in the image (in other words, in such a manner that “number of graduated tones”>“multiple values for head driving”).

The image data which has been subjected to half-tone processing is supplied from the half-tone processing unit 114 to the image memory 74. Furthermore, the image data which has completed half-tone processing and is supplied to the image memory 74 is also sent to the image analyzing unit 124. The image data which has completed half-tone processing is stored in the image memory 74 and furthermore, is analyzed by the image analyzing unit 124 to generate information (image position information data) relating to the positions where image information exists (image positions) and the positions where image information does not exist. The image position information data generated in this way is supplied from the image analyzing unit 124 to the defective ejection correction judgment unit 122 and is used to create correction information in respect of the defective ejection nozzles in the defective ejection correction judgment unit 122.

The image data which has undergone half-tone processing (half-tone image data) is also sent from the image memory 74 to the test pattern synthesizing unit 118.

In the test pattern synthesizing unit 118, the half-tone image data supplied from the image memory 74 and the image data relating to the test patterns (test pattern image data) are synthesized, and this synthesized image data is sent to the head driver (ejection device) 84. As described in detail below, the test patterns are dot patterns formed on recording paper by respective nozzles with the object of detecting defective ejection nozzles. The test pattern image data and half-tone image data are synthesized by the test pattern synthesizing unit 118 in such a manner that the test patterns are printed on an end portion of the recording paper.

Image data containing a synthesis of the half-tone image data and the test pattern image data is supplied to the head driver 84 from the test pattern synthesizing unit 118. The head driver 84 drives the head 50 on the basis of the image data supplied from the test pattern synthesizing unit 118 so that a desired image and the test patterns are recorded on the recording paper. In this way, a pattern forming device which forms a plurality of test patterns corresponding to each of the nozzles on recording paper, by means of ink droplets ejected from nozzles, includes the test pattern synthesizing unit 118 and a head driver 84.

According to the method of the present embodiment which is capable of identifying the position of a test pattern in units smaller than the read pixel pitch, it is possible to identify the position of a test pattern accurately, both in cases where the test pattern has a width substantially equal to the read pixel pitch in the reading direction, and in cases where the test pattern has a width of not more than 3 to 5 times the read pixel pitch.

The recording paper on which the image and the test patterns have been recorded is supplied to the paper output unit via the conveyance path (see arrow B in FIG. 9). In this case, a test pattern read image is generated by reading the test patterns recorded on the recording paper, by means of a test pattern reading unit (reading device) 136 which is disposed at an intermediate point in the conveyance path. The test pattern reading unit 136 acquires test pattern read image data based on the read pixel pitch by reading the recording paper 16 on which the test patterns 102 have been recorded, in the lengthwise direction of the head 50 (the nozzle row direction, main scanning direction, X direction) at a prescribed read pixel pitch. The data of this test pattern read image is supplied from the test pattern reading unit 136 to the defective ejection nozzle detection unit 132.

In the defective ejection nozzle detection unit 132, defective ejection nozzles (including defective nozzles which eject ink droplets that have a depositing position error greater than a prescribed value on the recording paper, and non-ejecting nozzles which do not eject ink droplets) are detected from the test pattern read image data supplied from the test pattern reading unit 136. The information data relating to defective ejection nozzles (defective ejection nozzle information) thus detected is sent from the defective ejection nozzle detection unit 132 to the defective ejection nozzle judgment unit 130.

The defective ejection nozzle judgment unit 130 includes a memory (not illustrated) which is capable of storing a plurality of sets of defective ejection nozzle information sent by the defective ejection nozzle detection unit 132. This defective ejection nozzle judgment unit 130 refers to the past defective ejection nozzle information stored in the memory and establishes the defective ejection nozzles on the basis of whether or not a nozzle has been detected as a defective ejection nozzle a prescribed number of times or more in the past. Furthermore, if a nozzle is judged to be a normal nozzle which has not been a defective ejection nozzle for a prescribed number of times or more in the past, then the defective ejection nozzle information is amended in the defective ejection nozzle judgment unit 130 in such a manner that a nozzle which has been treated as a defective ejection nozzle until then, for instance, changes status and that nozzle is subsequently treated as a normal nozzle.

The defective ejection nozzle information established in this way is sent by the defective ejection nozzle judgment unit 130 to the head driver 84 and the defective ejection correction judgment unit 122. Furthermore, if prescribed conditions are satisfied (for example, after printing a prescribed number of copies, after a job, when the user instructs so, or the like), the established defective ejection nozzle information is also supplied from the defective ejection nozzle judgment unit 130 to the defective nozzle information storage unit 126.

The head driver 84 disables driving of nozzles corresponding to defective ejection nozzles, on the basis of the defective ejection nozzle information supplied from the defective ejection nozzle judgment unit 130.

Furthermore, the defective ejection nozzle information sent to the defective nozzle information storage unit 126 is accumulated and stored in the defective nozzle information storage unit 126 and used as statistical information about defective ejection nozzles. The defective ejection nozzle information stored in the defective nozzle information storage unit 126 is sent to the defective ejection nozzle judgment unit 130 at a suitable timing as initial defective nozzle information. This initial defective nozzle information is information indicating which nozzles (corresponding to the CMYK inks) are defective nozzles; the initial values of the initial defective nozzle information are based on inspection information at shipment of the head, and the initial defective nozzle information is then updated appropriately at specified intervals on the basis of the defective ejection nozzle information stored in the defective nozzle information storage unit 126. The defective ejection nozzle judgment unit 130 stores the required defective ejection nozzle information, of this initial defective nozzle information, in a memory (not illustrated) at the start of printing and uses the stored information for the process of establishing the defective ejection nozzles.

The defective ejection correction judgment unit 122 generates correction information corresponding to image portions that require correction (image portions to be recorded by the defective ejection nozzles) from the defective ejection nozzle information sent by the defective ejection nozzle judgment unit 130, and supplies this correction information to the non-ejecting nozzle correction image processing unit 112.

Furthermore, the defective ejection correction judgment unit 122 compares the correction information generated in this way with the immediately previous correction information and detects whether or not new defective ejection nozzles have arisen (and more desirably, whether or not a prescribed number or more of new defective ejection nozzles have arisen) and the amount of correction information has increased. If it is observed that the correction information has increased, then a prescribed instruction is sent from the defective ejection correction judgment unit 122 to a defective ejection detection indicator unit 134.

The defective ejection detection indicator unit 134 which has received this prescribed instruction carries out processing which enables identification of a printed object including defective ejection on which recording based on the new defective ejection nozzles has been carried out (in other words, a printed object which has been printed without performing correction in respect of the new defective ejection nozzles). More specifically, the defective ejection detection indicator unit 134 performs the identifiable processing, such as attaching an adhesive label to printed objects, from the printed object (recording paper) in which a defect has been detected until a printed object where printing with complete correction has started. When printing after having completed the correction processing in respect of new defective ejection nozzles (when printing on the basis of image data (half-tone image data) after completing the correction processing), an instruction signal is sent to the defective ejection detection indicator unit 134 from the defective ejection correction judgment unit 122 in such a manner that the prescribed instruction described above is invalidated, and the defective ejection detection indicator unit 134 performs normal operation (normal indication).

Defective ejection nozzle detection and input image data correction processing is carried out suitably on the basis of the series of processing flows described above. Depending on the stability of the recording head 50, it is possible to adopt a composition where the aforementioned detection and correction processing is carried out only in respect of the first prescribed number of recording papers at the start of printing (a composition employing an off-line scanner may also be adopted), or a composition where the processing is carried out only when the user issues an instruction.

Next, the test patterns read in by the test pattern reading unit 136 will be described.

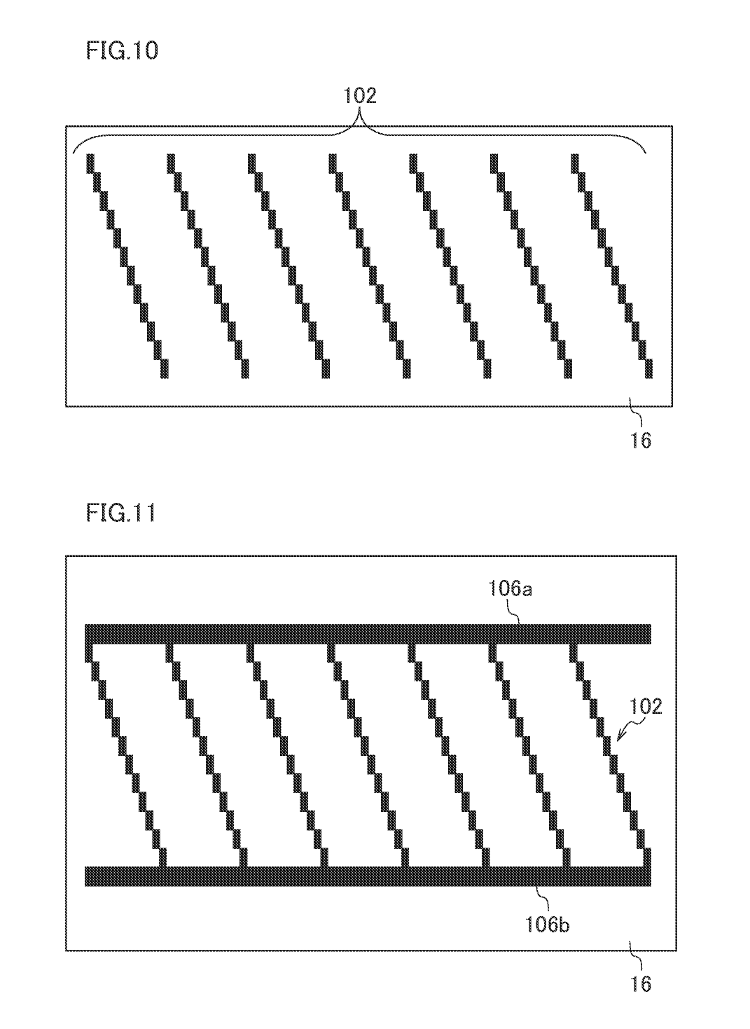

FIG. 10 is a diagram showing the basic shape of test patterns recorded on recording paper (a recording medium). FIG. 11 is a diagram showing one specific example of test patterns, and depicts test patterns including reference position detection bars. FIG. 10 and FIG. 11 show an enlarged view of an end portion of the recording paper 16 on which test patterns 102 are printed.

The basic portion of the line-shaped test patterns 102 is created on the recording paper 16 by conveying the recording paper 16 with the recording head and driving the plurality of nozzles of the recording head at a prescribed interval apart. In other words, the line-shaped test patterns 102 are formed by ejecting ink droplets for each nozzle block constituted by a group of nozzles at prescribed intervals, of the plurality of nozzles of the recording head, and the test patterns 102 are formed in a staggered fashion as shown in FIG. 10 by successively changing the nozzle block which ejects the ink droplets while conveying the recording paper 16. Since the test patterns 102 correspond to ejection of ink from respective nozzles, then by judging whether or not each respective test pattern 102 is formed appropriately, it is possible to detect whether or not ink droplets have been ejected appropriately from the corresponding nozzles.

In the present embodiment, as shown in FIG. 11 in particular, reference position detection bars 106a and 106b are also recorded respectively above and below the test patterns 102. As described hereinafter, the reference position detection bars 106a and 106b provide a reference for detecting the positions of the test patterns 102.

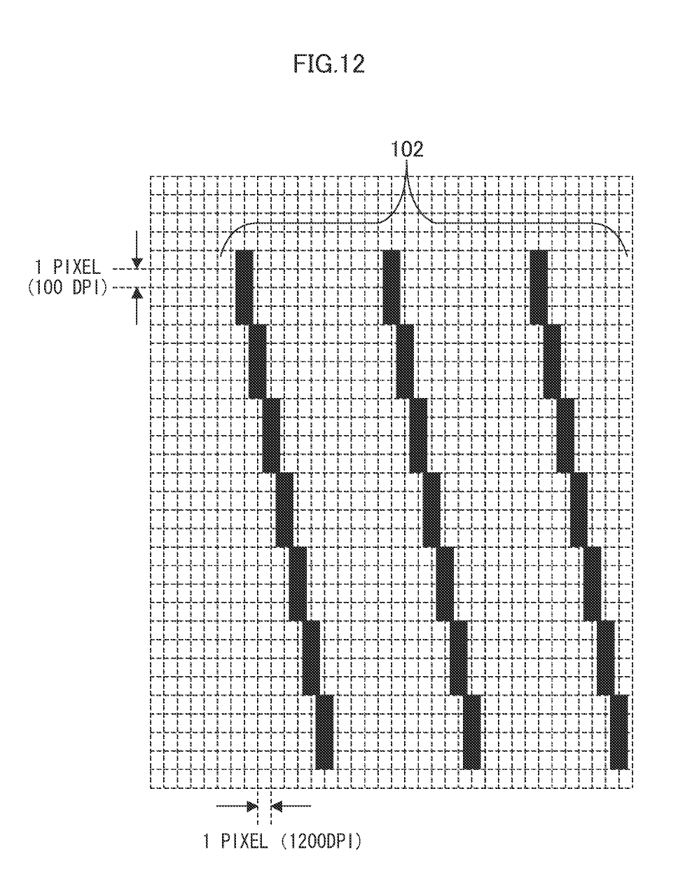

FIG. 12 is a conceptual diagram of a read image of test patterns when the reading resolution of the printing apparatus is 1200 dpi (dots per inch). In the read image in FIG. 12, the length in the lengthwise direction of each of the line-shaped test patterns 102 corresponds to four pixels at 100 dpi, and 48 pixels at 1200 dpi.

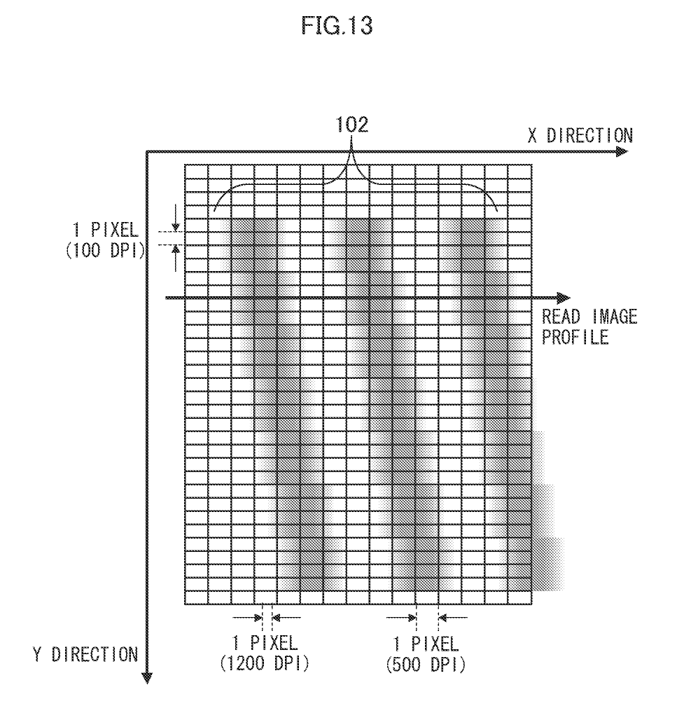

FIG. 13 is a conceptual diagram of a read image of test patterns when the reading resolution of the printing apparatus is 500 dpi. As FIG. 13 reveals, at a reading resolution of 500 dpi, the respective lines of the read image of the test patterns 102 are blurred and it is difficult to identify clear line edges.

In this way, whereas it is possible to identify the positions of the respective test patterns clearly by means of a read image of high resolution, if the read image is of low resolution, then it is difficult to identify the positions of the respective test patterns easily due to the blurring of the line edges. However, since a high-resolution image reading apparatus (scanner) is intrinsically expensive, then from the viewpoint of lowering costs, it is desirable to adopt a method capable of accurately identifying the positions of test patterns even using an image reading apparatus of low resolution.

Therefore, one example of a method of accurately identifying the positions of the test patterns from a low-resolution read image is described below.

In the description given below, the image density (light/shade) distribution of the read image in a cross-section in one direction (the X direction) is called a “profile”. This profile does not necessarily indicate the density (light/shade) distribution in one pixel only; for example, it is possible to employ the density (light/shade) distribution in terms of the X direction obtained from finding the average density (light/shade) in the Y direction, as a profile.

Firstly, a method of determining the positional error of each line position of a test pattern (line pattern) will be described.

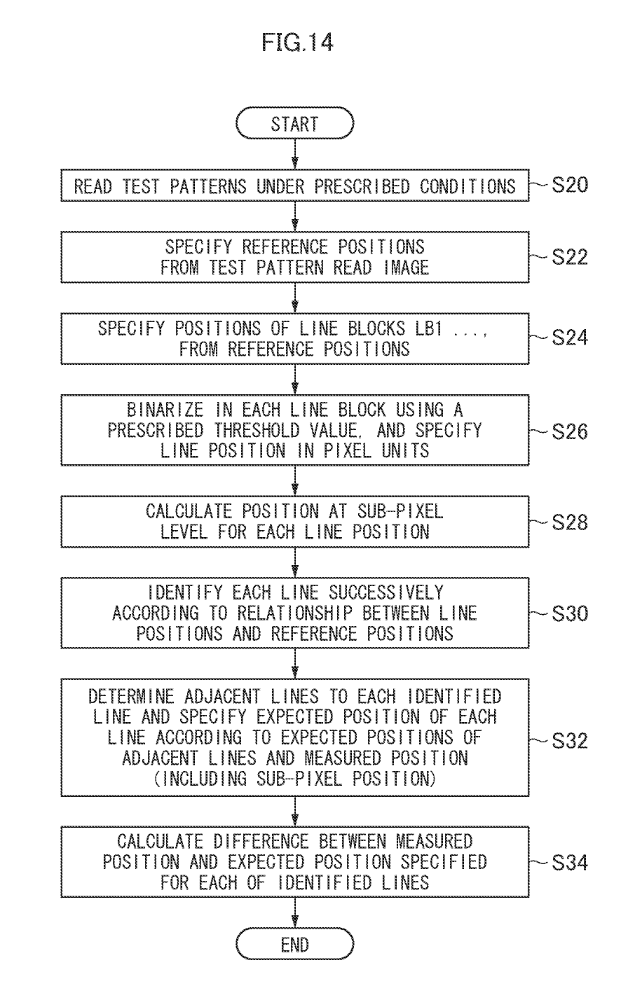

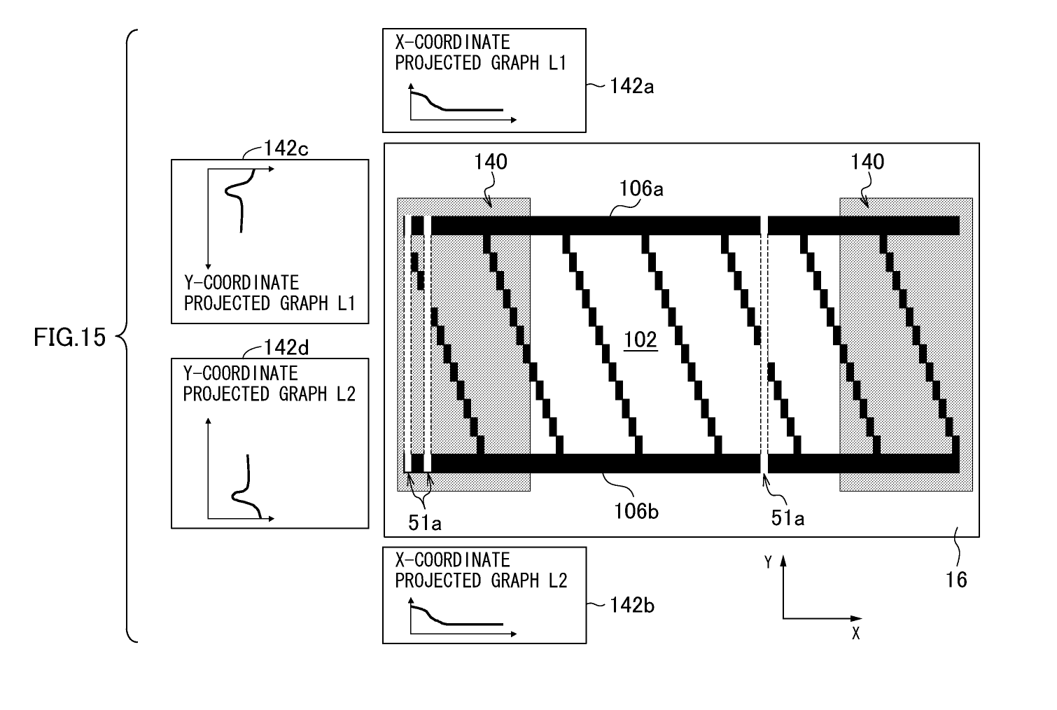

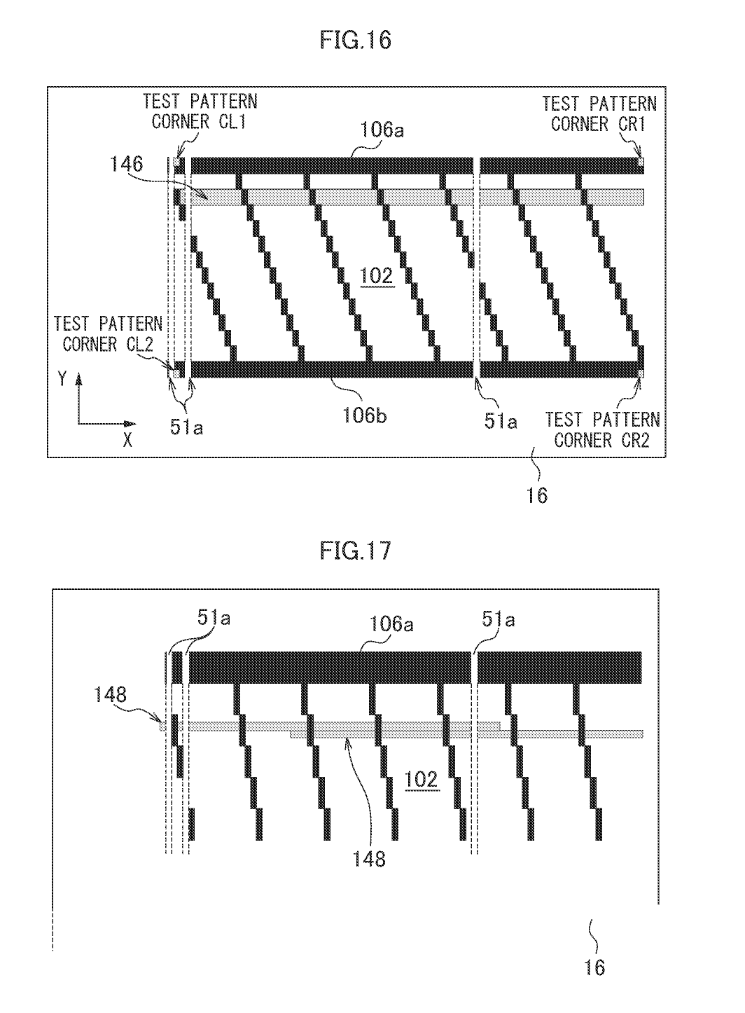

FIG. 14 is a flowchart showing a sequence for determining positional error of each line position of a test pattern. FIG. 15 is a diagram describing a method of determining reference positions for identifying line positions from a read image. FIG. 16 is a diagram showing the clipping of line blocks of nozzles on the basis of reference positions.

Test patterns 102 printed on the recording paper 16 by the nozzles of the recording head are read in as image data by the test pattern reading unit 136 (see FIG. 9), thereby generating image read data of the test patterns 102 (520 in FIG. 14). The reading conditions of the test patterns 102 in this step are, for example, 500 dpi in the X direction (main scanning direction) and 100 dpi in the Y direction (sub-scanning direction).

The reference positions used to identify the line position of each test pattern 102 (the reference position detection bars 106a and 106b) are specified from the image read data of the test patterns 102 (S22 in FIG. 14).

More specifically, as shown in FIG. 15, a reference position detection window 140 which is a rectangular region that necessarily includes an end portion of the test pattern 102, is set respectively in each end of the test pattern 102 (the left and right-hand ends in the X direction). Here, it is supposed that the positions of the test patterns 102 in the read image (RGB color image) can be identified to a certain degree from the relative positions of the test pattern 102, the recording paper 16 and the reading apparatus (the test pattern reading unit 136 in FIG. 9). The reference position detection windows 140 are each set so as to necessarily include one end portion of the test pattern 102 in a test pattern position range which is known to a certain extent.

Each reference position detection window 140 is divided into two regions, an upper region and a lower region, and optical density projection graphs 142a to 142d relating to the X direction and the Y direction (i.e. X-coordinate projected graph L1, X-coordinate projected graph L2, Y-coordinate projected graph L1, Y-coordinate projected graph L2, X-coordinate projected graph R1, X-coordinate projected graph R2, Y-coordinate projected graph R1, Y-coordinate projected graph R2) are created in the respective regions. The X-coordinate projected graph L1 (142a) and the Y-coordinate projected graph L1 (142c) referred to here are the projected graphs in the upper region of the left-end-side reference position detection window 140 in FIG. 15. Similarly, the X-coordinate projected graph L2 (142b) and the Y-coordinate projected graph L2 (142d) referred to here are the projected graphs in the lower region of the left-end-side reference position detection window 140. Furthermore, although not shown in the drawings, the projected graphs in the upper region of the right-end-side reference position detection window 140 are called the X-coordinate projected graph R1 and the Y-coordinate projected graph R1, and the projected graphs in the lower region of the right-end side reference position detection window 140 are called the X-coordinate projected graph R2 and the Y-coordinate projected graph R2. These projected graphs are created for each color of RGB, and the X(Y)-coordinate projected graph having the highest contrast is used. The following description relates to calculation for the color image plane having the highest contrast.

The Y-coordinate projected graph L1 is described here by way of an example. The Y-coordinate projected graph L1 is created by averaging, in the X axis direction, the density tone values in the upper portion of the left-end-side rectangular region (the reference position detection window 140). This rectangular region includes a blank margin of the paper, a first reference position detection bar 106a of the test pattern 102, and the respective line-shaped test patterns 102. Therefore, in the Y-coordinate projected graph L1 (142c), locations representing a blank margin (white), a first reference position detection bar 106a (dark density) and line portions (light density) are arranged in sequence. Therefore, by detecting an edge where the density changes from white to a dark density, it is possible to determine the Y-coordinate of the upper left end of the first reference position detection bar 106a.

Furthermore, the X-coordinate projected graph L1 (142a) is created by averaging, in the Y axis direction, the density tone values in the upper portion of the left-end-side rectangular region (the reference position detection window 140). This rectangular region includes a blank margin of the paper, and the first reference position detection bar 106a of the test pattern 102 (and the line-shaped test pattern 102 which overlaps with the first reference position detection bar 106a). Therefore, in the X-coordinate projected graph L1 (142a), locations representing a blank margin (white), a first reference position detection bar 106a and line portions (dark density) are arranged in sequence. Therefore, by detecting an edge where the density changes from white to a dark density, it is possible to determine the X-coordinate of the upper left end of the first reference position detection bar 106a.

The other projected graphs can also be analyzed in a similar fashion. As a result of this, it is possible to determine XY coordinates for each corner of the first reference position detection bar 106a and the second reference position detection bar 106b (the test pattern corners CL1, CL2, CR1 and CR2), as shown in FIG. 16. These test pattern corners CL1, CL2, CR1 and CR2 are used as reference positions.

Even if the head 50 includes non-ejecting nozzles and the first reference position detection bar 106a and the second reference position detection bar 106b are printed by a group of nozzles including non-ejecting nozzles, since the first reference position detection bar 106a and the second reference position detection bar 106b are solid portions which are continuous in the X direction (nozzle direction) and the Y direction, then the print locations 51a corresponding to defective ejection nozzles (non-ejecting nozzles) have little effect on the position detection results. Furthermore, it is also possible to specify the corresponding ink by analyzing the RGB color of the respective portions of the first reference position detection bar 106a and the second reference position detection bar 106b.

Next, the positions of the line blocks 146 are determined from the test pattern corners CL1, CL2, CR1 and CR2 which are reference positions (S24 in FIG. 14). Each line block 146 is constituted by one group of test patterns 102 which are aligned in the X direction as shown in FIG. 16, and the line blocks 146 which are mutually adjacent in the Y direction are printed by ink droplets from nozzles which are mutually adjacent in the one-row nozzle arrangement (projected nozzle arrangement). Consequently, each of the test patterns 102 is allocated to one of the line blocks 146 which are aligned in sequence in the Y direction.

Firstly, the amount of rotation of the test patterns 102 and the magnification rate error in the X direction and the Y direction of the test patterns 102 (the disparity between the actual magnification rate and the designed magnification rate) are calculated from the relative positions of the test pattern corners CL1, CL2, CR1 and CR2. Since the layout of the test patterns 102 is information that is already known, then the positions of the line blocks 146 (the relative positions from the test pattern corners CL1, CL2, CR1 and CR2, and the coordinates of the four corners of the rectangular shape) are determined on the basis of the known depositing position design information (for example, the X-direction pitch, the Y-direction pitch, the X-direction width and the Y-direction length of the test pattern 102, and the like). The relative positions of the line blocks 146 on the read image are calculated from the test pattern corner CL1 on the basis of the magnification rate error and the angle of rotation which have been calculated previously. In this case, even if there are locations 51a which are printed by defective ejection nozzles, the first reference position detection bar 106a and the second reference position detection bar 106b are hardly affected by the locations 51a corresponding to the defective ejection nozzles, and therefore it is possible to calculate the positions of the line blocks 146 accurately. In this way, the positions of all of the line blocks 146 are identified.

Thereupon, the density in each line block 146 is binarized using a prescribed threshold value, and the line positions in each test pattern 102 are specified in the pixel units of the read image (read pixel pitch units) (S26 in FIG. 14). The prescribed threshold value used in this step may be a relative value with respect to the tone value of the white background, or may be changed with respect to the type of recording paper 16. Furthermore, if there is a density difference equal to or greater than a prescribed amount in the ink density, depending on the type of paper, then it is also possible to specify a threshold value by analyzing the image. Furthermore, it is also possible to specify the threshold value by using a commonly known method, such as discriminant analysis or a percentile method, or the like. Alternatively, it is also possible to use a relative value between the tone value of the white background and the tone value of the first reference position detection bar 106a and the second reference position detection bar 106b; for example, the tone value of the first reference position detection bar 106a and the second reference position detection bar 106b is taken as 100%, the tone value of the white background is taken as 0%, and a tone value corresponding to X% can be taken as a threshold value.

In binarizing the density distribution in the line blocks 146 by means of this threshold value, a profile is created of the portion (central region) of each line block 146 which is not affected by the other line blocks 146 adjacent to the upper and lower sides, and this profile is then binarized. If there is a gradient in the test pattern, then the location which is treated as a central region that is not affected by the other line blocks 146 to the upper and lower sides gradually shifts in the up/down direction, and therefore the effects of the other line blocks 146 on the upper and lower sides are liable to emerge as error. In cases of this kind, as shown in FIG. 17, the analysis regions 148 for creating a profile are overlapped partially within the line block 146, and for this overlapped portion, a profile is created by averaging the results on this overlapped portion. The presence or absence of a gradient in a test pattern is detected from the test pattern corners CL1, CL2, CR1 and CR2.

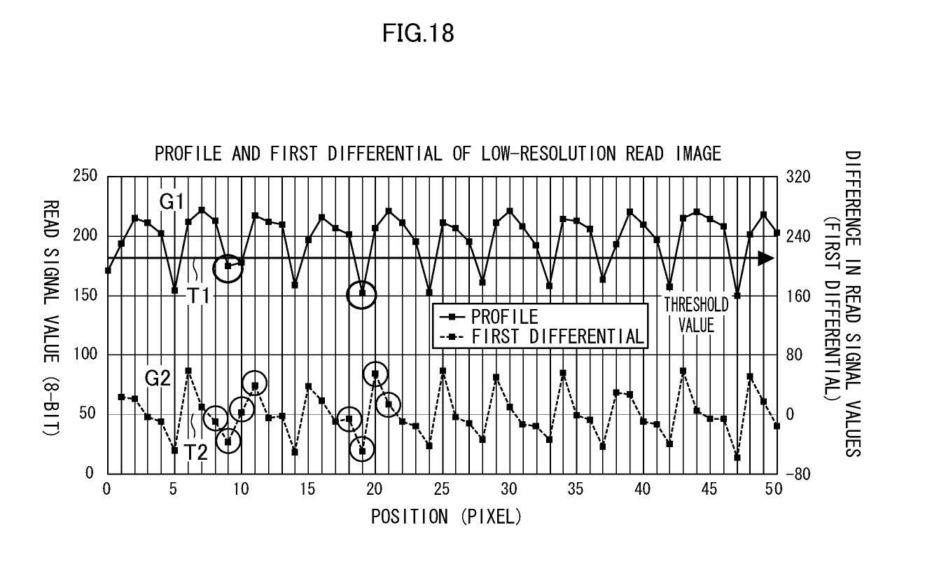

FIG. 18 shows a graph in which the density distribution profile in each line block has been binarized. The graph G1 in FIG. 18 plots the pixel position (read position) of the read image of the test pattern 102 on the X axis and plots the read signal value (8-bit) of the tone value (optical density) of the read image of the test pattern 102 on the Y axis (see the left-hand Y axis in FIG. 18). Furthermore, the graph G2 plots the first differential of the read signal value of the graph G1, on the Y axis (see the right-hand Y axis in FIG. 18). A threshold value T1 is set for the graph G1, a threshold value T2 is set for the graph G2, and read pixel positions which are below the threshold values T1 and T2 (a read signal value smaller than the threshold value T1, or a first differential value smaller than the threshold value T2) indicate the corresponding positions of each test pattern 102 based on the read pixel pitch. If a plurality of continuous pixels are situated below the threshold value, then the central pixel of the plurality of pixels may be taken as the line position, or if the number of continuous pixels is two, then the pixel position showing the smaller value (tone value) may be set as the line position.

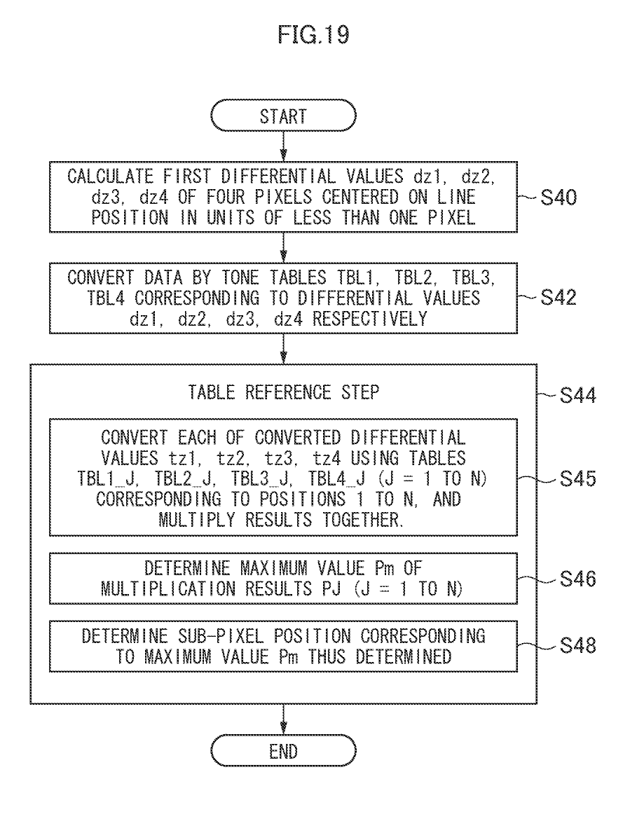

Next, the positions of units of less than one pixel based on the read pixel are calculated in respect of each line position of the test patterns 102 (S28 in FIG. 14). FIG. 19 is a flowchart showing a process of calculating a position in units of less than one pixel for a line position of each test pattern.

For a pixel position (Xᵢ) which has a read signal value smaller than the threshold value T1 of the graph G1 in FIG. 18, the first differential values (dz1, dz2, dz3, dz4) of the graph G2 are calculated on the basis of five pixels Xᵢ₋₂, Xᵢ₋₁, Xᵢ, Xᵢ₊₁, Xᵢ₊₂) which include that pixel and the two adjacent read pixels to the front and rear sides (S40 in FIG. 19). By determining the first differential value in this way, it is possible to ascertain the tonal change information more clearly.

In the present embodiment, the first differential values dz1, dz2, dz3, dz4 obtained from the read image data (and more precisely, the converted differential tone values tz1, tz2, tz3 and tz4 where the tonal values have been adjusted as described blow) are used as characteristic values at the corresponding position of the object test pattern and at the adjacent pixel positions.

If the profile image data (read signal value) of each line block LBk is represented by PFIk(X), then the first differential values of the graph G2 (dz1, dz2, dz3, dz4) which are determined for a certain pixel position (Xᵢ) having a smaller read signal value than the threshold value T1 in the graph G1 are found as described below.

Formula 1

dz1=PFIk(Xᵢ₋₁)−PFIk(Xᵢ₋₂)

dz2=PFIk(Xᵢ)−PFIk(Xᵢ₋₁)

dz3=PFIk(Xᵢ₊₁)−PFIk(Xᵢ)

dz4=PFIk(Xᵢ₊₂)−PFIk(Xᵢ₊₁)

Correction to reflect the data value compression (reduction of the number of tone values) and the characteristics of each ink is carried out by means of tone tables TBL1, TBL2, TBL3, TBL4 which are previously prepared (desirably in respect of each of the inks (C, M, Y, K)) on the basis of the first differential values which have been determined in this way (S42 in FIG. 19). Corresponding graduated tone tables TBL1, TBL2, TBL3, TBL4 are prepared respectively for the first differential values (dz1, dz2, dz3, dz4).

Formula 2

tz1=TBL1 (dz1)

tz2=TBL2 (dz2)

tz3=TBL3 (dz3)

tz4=TBL4 (dz4)

Thereupon, the multi-dimensional (four) corrected first differential values (tz1, tz2, tz3, tz4) are input to a multi-dimensional table (position table) and a position of a test pattern in units of less than one pixel based on the read pixel pitch is output (S44 in FIG. 19).

The multi-dimensional table used here is a table which associates a characteristic value (the first differential value after correction) at the corresponding position of a test pattern and the characteristic values (the first differential values after correction) at the adjacent pixel positions, with a candidate position having the highest possibility of arrangement of the test pattern and allocated at a shorter distance than the read pixel pitch from the corresponding position of the test pattern. When the characteristic value (first differential value) at the corresponding position of a test pattern and the characteristics values (first differential values) at the adjacent pixel positions are input to this multi-dimensional table, a position (candidate position) of the line pattern is output in units of less than one pixel based on the read pixel pitch (candidate position output step). More specifically, this multi-dimensional table is prepared in a format which reflects a conformance deduction step and a candidate position acquisition step.

The conformance deduction step referred to here is a step in which a conformance function corresponding to each of a plurality of input values (first differential values, multi-dimensional input values), which is prepared for each of the plurality of candidate positions and associates an input value (characteristic value) with a conformance representing the possibility of arrangement of a line pattern, is used to deduce a conformance for each of the plurality of candidate positions from the input value (first differential value) at the corresponding position based on the reading pixel pitch of the line pattern and the input values (first differential value) at the adjacent pixel positions. Furthermore, the candidate position acquisition step indicates a process for determining a candidate position having the best conformance, on the basis of the conformance of each of the plurality of candidate positions deduced.

Furthermore, in the candidate position output step, the characteristic value (first differential value) at the corresponding position of the test pattern and the characteristic values (first differential values) at the adjacent pixel positions are input to the multi-dimensional table as multi-dimensional input values, and thereby a candidate position showing the best conformance is output.

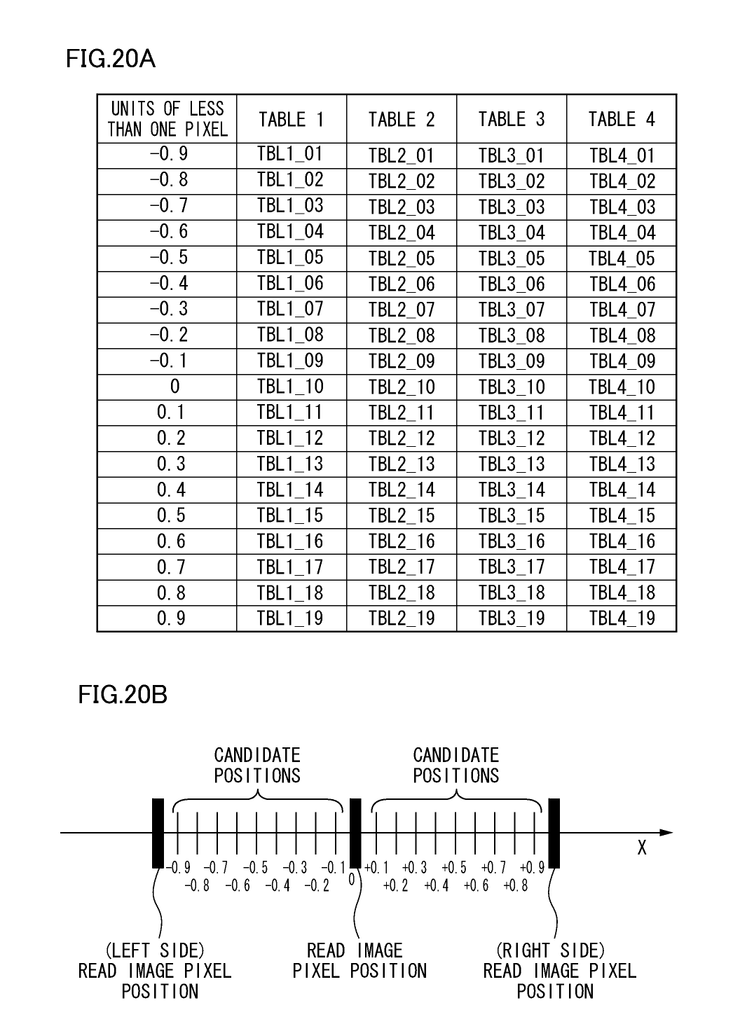

The respective processing steps which are reflected in this multi-dimensional table are described below with reference to FIG. 20A to FIG. 25.

FIG. 20A is a table showing the relationship between a conformance function table for specifying a line position at the sub-pixel (i.e. less than one pixel) level and positions in sub-pixel units (i.e. in units of less than one pixel); and FIG. 20B shows a schematic view of the relationship between pixel positions on a read image and candidate positions. In the example shown in FIG. 20A, the tone tables TBL1_01 to TBL4_19 correspond to a total of 19 candidate positions in a range of divisions of 0.1 of a pixel, from −0.9 to +0.9, in the X direction. The candidate positions are set in the reading direction in units of less than one pixel based on the read pixel pitch and also include the corresponding position (0) of the test pattern 102 in the read pixel pitch units. In other words, the value “0” shown in FIG. 20A and FIG. 20B indicates a location on the pixel position of the read image; the values from “0” to “−0.9” respectively indicate positions progressively nearer the read image pixel position which is adjacent on the left-hand side in the X direction, and the values from “0” to “+0.9” respectively indicate positions progressively nearer the read image pixel position which is adjacent on the right-hand side in the X direction.

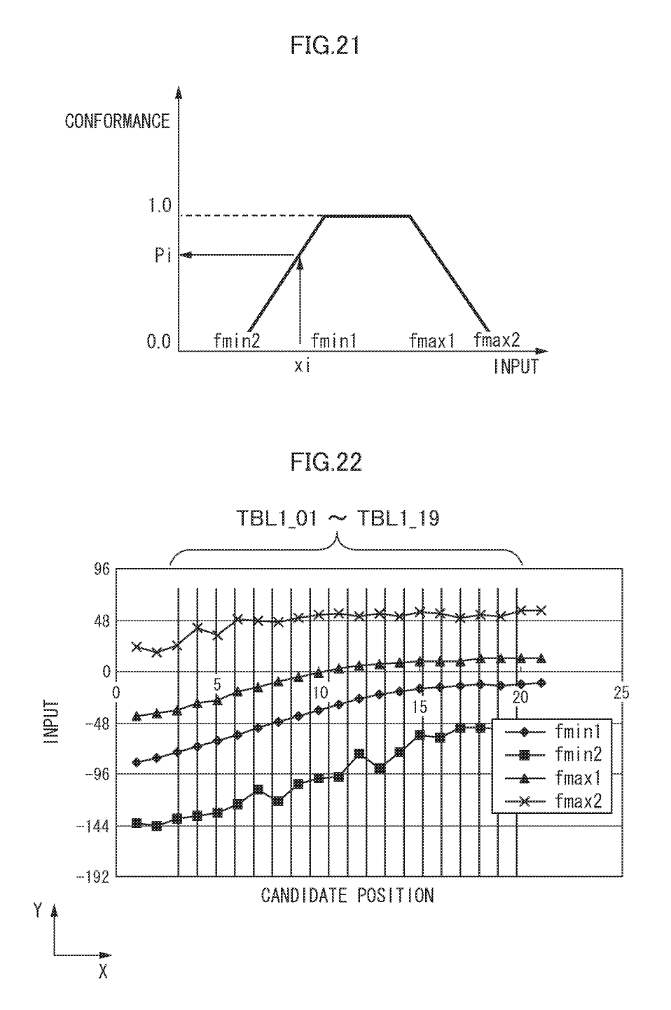

FIG. 21 is a graph showing the basic shape (basic concept) of a conformance function table TBLi_j (i=1 to 4, j=01 to 19), where the X axis represents the input value (tone value, first differential value) and the Y axis represents a conformance.

The “conformance” referred to here is an index of the possibility of arrangement of a line pattern, and indicates the probability that the object line pattern is present in the corresponding candidate position. The distribution of the conformance relating to candidate positions can be specified appropriately by various different methods; for example, the conformance distribution can be found by steps S1 to S6 below.
S1) The line optical density distribution is specified by a computer on the basis of the characteristics (image formation resolution, optical density, dot diameter, dot distribution, and the like) of the printer apparatus (inkjet recording apparatus 10).
S2) A read image is calculated from the optical density distribution derived by computer, and a line profile is also specified by computer, on the basis of the characteristics of the reading apparatus (reading resolution, aperture response, MTF, etc.), in respect of an ideal line profile.
S3) A prescribed characteristic amount is specified on the basis of the computer-generated line profile.
S4) A set of computer-generated positions (correct positions) are determined in relation to the prescribed characteristic amount, by performing steps S1 to S3 above, while changing the line position.
S5) The calculations in S1 to S4 above are repeated while changing external factors (variation in optical density, variation in dot diameter, variation in dot distribution, reading noise, variation in magnification rate, etc.), and a correct probability distribution (conformance) is determined in respect of the prescribed characteristic amount. In this case, the method of applying variation is adjusted on the basis of the characteristics of the printer apparatus and reading apparatus.
S6) The probability distribution (conformance) obtained in S5 is fitted to match the characteristics of the system. The characteristics of the system referred to here are the resources which can be allocated in order to maintain and use the probability distribution, and the reason why a simple trapezoid shape is used as described below is because this enables the number of data points to be reduced. Provided that the resources are available, it is also possible to use the calculated distribution directly, without modification.

In the present embodiment, as shown in FIG. 21, the conformance function table TBLi_j has a trapezoid shape, and the four values which define this trapezoid shape fmin2, fmin1, fmax1, fmax2, correspond respectively to the left end of the lower edge, the left end of the upper edge, the right end of the upper edge and the right end of the lower edge; the upper edge of the trapezoid shape corresponds to a conformance of 1. By using this conformance function table TBLi_j, it is possible to derive the conformance (Pi) relating to an input value (xi) of a first differential value (tzi, i=1 to 4).

FIG. 22 is a graph showing a plurality of conformance function characteristics for specifying a position in units of less than one pixel, and this graph corresponds to the initial first differential value tz1. The X axis indicates a position in units of less than one pixel of the read pixel pitch, and the Y axis indicates an input value (tone value, first differential value). The four values described above, fmin2, fmin1, fmax1, fmax2, which define the conformance function table are plotted on the graph. In FIG. 22, each of the 19 straight lines extending in the Y direction represents a function table (conformance function table) indicating a degree of conformance (conformance function characteristics) corresponding to the candidate positions j=01 to j=19, sequentially from the left-hand side, and the vertical cross-section (vertical direction characteristics) at each candidate position j (j=01, 19) indicate the trapezoid shape (see FIG. 21) relating to TBL1_j (j=1, . . . , 19).

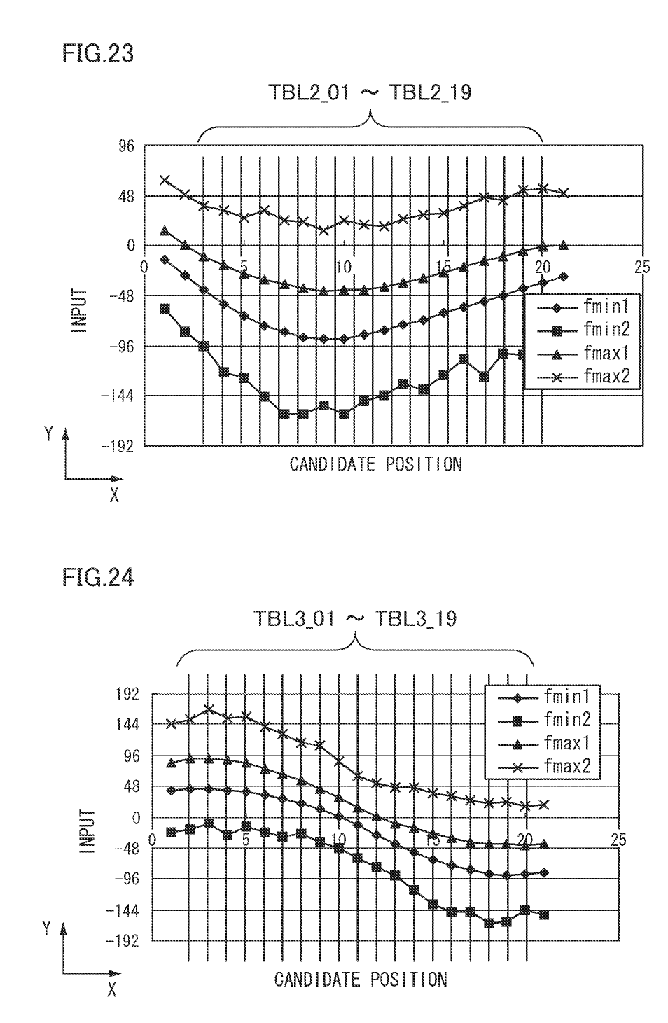

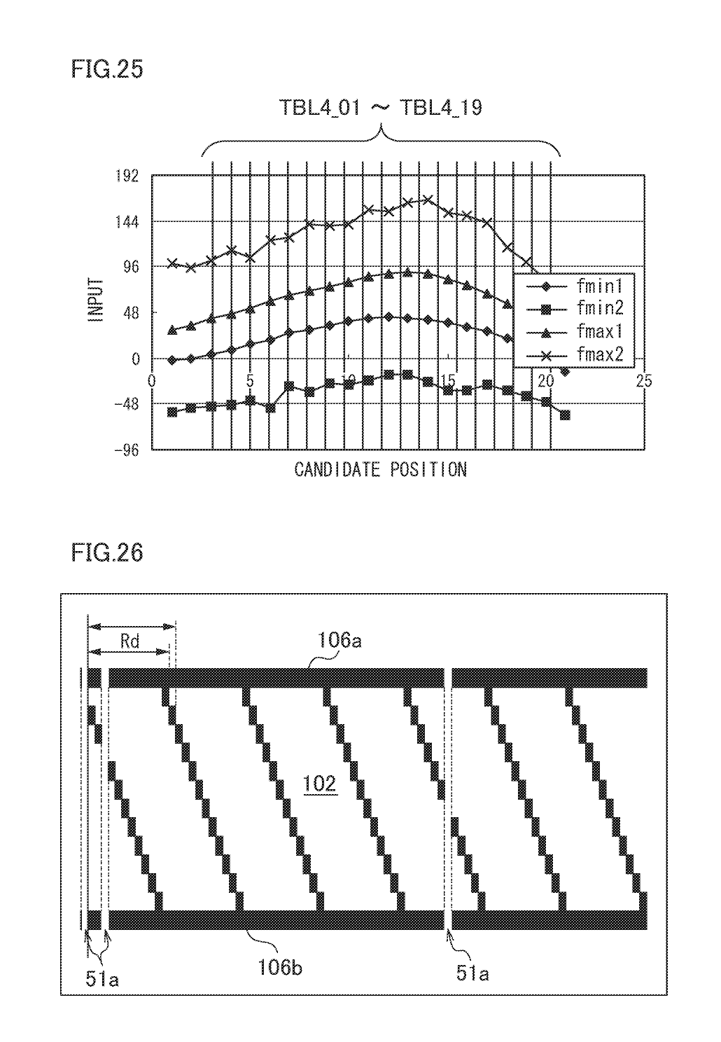

Similarly, FIG. 23 to FIG. 25 are graphs indicating a plurality of conformance function characteristics for specifying positions at the sub-pixel level (i.e. in units of less than one pixel); FIG. 23 corresponds to a second first differential value (tz2), FIG. 24 corresponds to a third first differential value (tz3), and FIG. 25 corresponds to a fourth first differential value (tz4).

In this way, a set of conformances for the first to fourth first differential values (tz1 to tz4) derived from the read data at the position of the test pattern 102 and the adjacent pixel positions is calculated so as to correspond to each of a plurality of candidate positions. More specifically, a plurality of sets of these conformances are derived for the respective candidate positions.

An overall conformance Pj at each candidate position j (j=01 to 19) is derived from the product of the set of conformances of the first to fourth first differential values (tz1 to tz4) thus determined (TBL1_(tz1), TBL2_j (tz2), TBL3_(tz3), TBL4_(tz4)) (S45 in FIG. 19). In this step, the product of conformances (TBL1_j (tz1), TBL2_j (tz2), TBL3_j (tz3), TBL4_j (tz4)) is calculated for each candidate position j (j=01 to 19).

Formula 3

Pj=TBL1_{—}j (tz1)×TBL2_{—}j (tz2)×TBL3_{—}j (tz3)×TBL4_{—}j (tz4) (j=01, . . . . , 19)

Thereupon, the candidate position corresponding to the set of conformances showing the highest probability of the test pattern 102 being present is detected as the candidate position having the best conformance More specifically, in order to determine the candidate position having the best conformance, the maximum value Pm of the overall conformances Pj calculated for respective candidate positions (j=01, . . . , 19) is found (S46 in FIG. 19), and the position m showing this maximum value Pm (namely, the position Q in units of less than one pixel of the read pixel pitch) is identified from among the candidate positions j (j=01, . . . , 19) (S48 in FIG. 19). In this step, if there are a plurality of candidate positions showing a maximum value, then the average value of the plurality of candidate positions showing the maximum values is derived; for instance, if P4, P5 and P6 show a maximum value, then the following calculation is made: (4+5+6)/3=5 (average value). If the average value derived in this way is not an integer, for example, the position in units of less than one pixel of the reading pixel pitch which corresponds to the integer part of the average value is taken as Q1, the position in units of less than one pixel of the reading pixel pitch which corresponds to the integer part of the average value plus 1 is taken as Q2, the fraction part of the average value is taken as s, and the position at the sub-pixel level can be found by Q=Q1×(1−s)+Q2×s.

In this way, the position Q in units of less than one pixel of the reading pixel pitch is calculated for all of “the pixel positions Xᵢ having a read signal value smaller than the threshold value T1 of the graph G1 (see FIG. 18)” in the line block 146.

In the present embodiment, an output value (a position in units of less than one pixel) corresponding to a set of input values (first differential values) is calculated in this way so as to cover all combinations of a multi-dimensional (four-dimensional) table, and this correspondence is stored. The multi-dimensional table created in this way is referred to when specifying the position of a test pattern in units of less than one pixel. In this way, the pixel position X, and the position Q in units of less than one pixel are determined.

The relationship between the line positions and the corresponding nozzle numbers is identified on the basis of the relationship between the line positions of the test pattern 102 thus calculated and the reference positions (test pattern corners CL1, CR1, CL2, CR2 (see FIG. 16)). The angle of rotation of the test pattern 102 and the magnification rate error in the X direction and Y direction are calculated from the positional relationship of the test pattern corners CL1, CR1, CL2, CR2.

Furthermore, since the layout of the test pattern 102 can be handled as existing information, then the positions of the respective nozzles in the line block positions (the relative positions of the nozzles from the test pattern corner CL1 (corresponded)) are determined from the existing test pattern design information. As shown in FIG. 26, the relative position Rd on the read image of the line position of a test pattern 102, with respect to the test pattern corner CL1, is calculated on the basis of the previously determined magnification rate error and angle of rotation, and the coordinates of the position on the profile can be determined from this calculated value Rd.

The distance to the line position of the test pattern 102 determined previously by binarization of the profile (in pixel units and sub-pixel units) is compared with the coordinates on the profile of the nozzles based on the test pattern design information which is determined in this way, and the line position of the test pattern 102 corresponding to each nozzle is determined by specifying the closest line position of the test pattern 102 (S30 in FIG. 14).

Next, the adjacent line positions of each line of the test patterns 102 are determined and the average position of the plurality of adjacent lines is used as a reference position (S32 in FIG. 14).

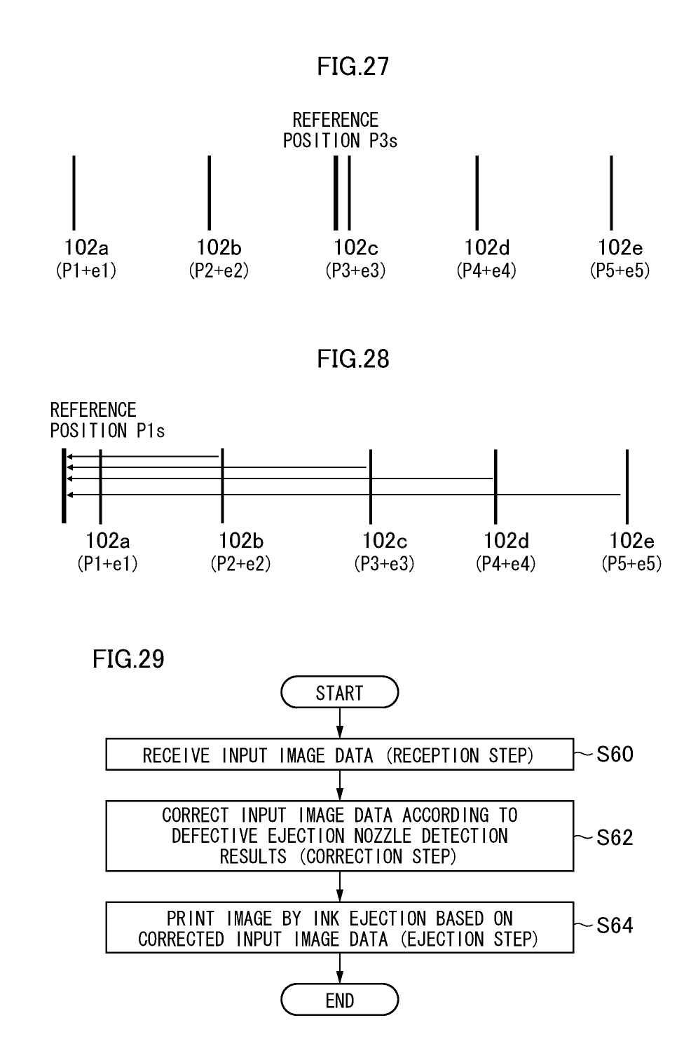

FIG. 27 is a diagram showing one example of a method of calculating a reference position and illustrates a method of calculating a reference position from the positions of the adjacent lines (test patterns) on either side. Furthermore, FIG. 28 is a diagram showing a further example of a method of calculating a reference position and illustrates a method of calculating a reference position from the position of the adjacent line (test pattern) on one side.

In the present embodiment, if the test patterns are arranged at substantially equidistant intervals, then an average position of the test patterns 102 is calculated as a reference position from the positions of nozzles of the same number on the left and right-hand sides of the nozzle under consideration. For example, in the example shown in FIG. 27, if the position of the line under consideration (test pattern) 102c is taken as P3+e3, the positions of the two lines 102a and 102b which are adjacent on the left-hand side are taken as P1+e1 and P2+e2, and the positions of the two lines 102d and 102e which are adjacent on the right-hand side are taken as P4+e4 and P5+e5, then the reference position P3s of the line under consideration 102c is determined by the following equation.

$$\begin{matrix}P 3 s = ( P 1 + e 1 + P 2 + e 2 + P 4 + e 4 + P 5 + e 5 ) / 4 \\ = ( P 1 + P 2 + P 4 + P 5 ) / 4 + ( e 1 + e 2 + e 4 + e 5 ) / 4\end{matrix} \qquad Formula 4$$

Furthermore, in the case of a test pattern in an end portion where equal numbers of adjacent test patterns are not present on the left and right-hand sides, a plurality of reference lines (reference nozzles) are set on the side where there is a prescribed number or more of lines continuously, the expected positions are determined for each reference line (reference nozzle) on the basis of the average line pitch (average nozzle pitch) L and the line number difference (nozzle number difference), and the average value of the expected positions of the plurality of reference lines (reference nozzles) is taken as the reference position. In the example shown in FIG. 28, for example, the position of the line under consideration (test pattern) 102a is taken as P1+e1, the position of the next adjacent reference line (reference nozzle) 102b is taken as P2+e2, the position of the next adjacent reference line (reference nozzle) 102c is taken as P3+e3, the position of the next adjacent reference line (reference nozzle) 102d is taken as P4+e4, the position of the next adjacent reference line (reference nozzle) 102e is taken as P5+e5, and the reference position P1s of the line under consideration 102a is determined by the following equation.

Formula 5

P1s=(P2+e2−L)+(P3+e3−×2)+(P4+e4−L×3)+(P5+e5−L×4))/4

In the foregoing description, e1 to e5 indicate error components and by assuming a normal distribution and averaging these error components (for example, by (e1+e2+e4+e5)/4), it can be expected that the effects of these error components can be sufficiently reduced. Furthermore, in the calculation described above, if a line (test pattern 102) created by a defective ejection nozzle (non-ejecting nozzle) is included, then rather than using the actual measurement values, it is also possible to carry out the calculation described above using the expected value for each line (nozzle). Moreover, it is also possible to change the number of lines (the number of nozzles) in the test patterns which are used for the calculations described above, and these calculations may also be performed using the data for three or more adjacent lines (adjacent nozzles), and furthermore, these calculations may also be performed by using data for lines (nozzles) included in another nozzle block which is adjacent in the Y direction.

The difference between the reference position and the measured position is calculated for each line position of the test patterns determined in this way (S34 in FIG. 14). It is judged from this difference whether or not the actual depositing position (line position) of each test pattern is separated by a prescribed distance or more from the reference position, and if the position is separated by a prescribed distance or more, then a nozzle corresponding to the position is detected as a defective ejection nozzle.

### General Flow of Processing

As described above, according to the inkjet recording apparatus of the present embodiment, since the depositing positions on the recording paper of the ink droplets ejected from the respective nozzles can be ascertained accurately, then it is possible to subject the input image data to precise correction processing which compensates for depositing position error. The whole of the processing sequence based on the various processing described above is explained below.

FIG. 29 is a flowchart showing an overall flow of image printing. When input image data for a desired image supplied from the host computer 86 (see FIG. 6) is received via the communications interface (receiving device) 70 (reception step S60 in FIG. 29), the input image data is corrected by color conversion processing (in the color conversion processing unit 110 in FIG. 9), defective ejection nozzle correction processing (in the non-ejecting nozzle correction image processing unit 112), half-tone processing (in the half-tone processing unit 114), test pattern synthesis processing (in the test pattern synthesizing unit 118), and the like (correction step in S62). Therefore, in the present embodiment, the correction processing device which corrects the input image data includes the color conversion processing unit 110, the non-ejecting nozzle correction image processing unit 112, the half-tone processing unit 114 and the test pattern synthesizing unit 118 in FIG. 9.

By means of the head driver 84 causing ink droplets to be ejected toward the recording paper 16 from the nozzles 51 of each of the heads 50, on the basis of the corrected input image data (ejection step S64), it is possible to print a desired image clearly on the recording paper 16.

In the correction step (S62) described above, the ejection of ink droplets from a defective ejection nozzle is compensated by other normally functioning nozzles, and defective ejection nozzle correction processing (in the non-ejecting nozzle correction image processing unit 112) for preventing the ejection of ink droplets from a defective ejection nozzle is applied to the input image data. The defective ejection nozzle correction processing is carried out on the basis of the read image data of the test pattern 102 sent from the test pattern reading unit 136, in the defective ejection nozzle detection unit 132 (see FIG. 9).

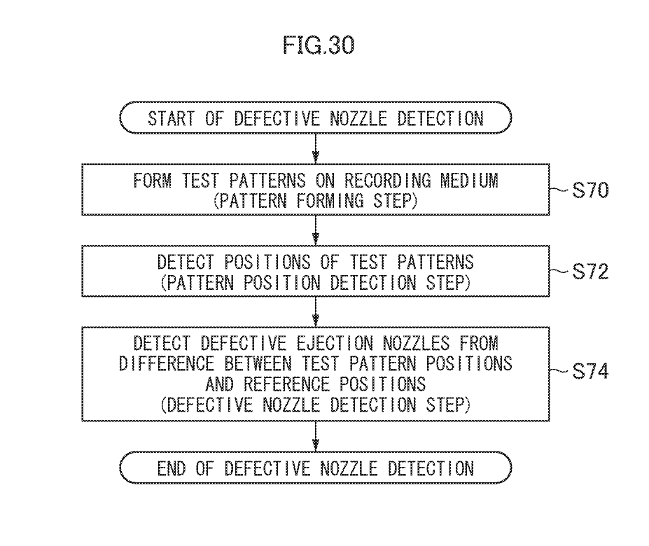

FIG. 30 is a flowchart showing a flow of defective ejection nozzle detection. Firstly, a plurality of test patterns 102 (see FIG. 10) corresponding to respective nozzles 51 are formed in a blank margin of the recording paper 16 by ink droplets ejected from nozzles 51, on the basis of image data from the test pattern synthesizing unit 118 (see FIG. 9) (pattern forming step S70 in FIG. 30). The image of the test patterns 102 is then read in and the recording positions of the test patterns 102 are detected (pattern position detection step in S72). The recording positions of the test patterns 102 thus detected are compared with the reference positions (see FIG. 27 and FIG. 28) and it is detected whether or not the nozzle 51 corresponding to each of the test patterns 102 under comparison is a defective ejection nozzle on the basis of whether or not the recording position is separated by a prescribed distance or more from the reference position (whether or not the distance with respect to the reference position is equal to or greater than a prescribed threshold value) (the defective nozzle detection step in S74). This detection of a defective ejection nozzle is carried out for all of the nozzles 51 of the head 50, and therefore it is possible to detect in a suitable fashion not only nozzles which have changed from a normal state to a defective ejection state, but also nozzles which have changed from a defective ejection state to a normal state (see the defective ejection nozzle judgment unit 130 in FIG. 9). The aforementioned reference position which forms a reference for the depositing position of the ink droplets on the recording paper 16 is set for each nozzle 51 (test pattern 102).

It is judged appropriately whether or not a nozzle is a non-ejecting nozzle which cannot eject ink droplets and cannot record a test pattern on the recording medium, on the basis of the presence or absence of a corresponding test pattern.

In the pattern position detection step (S72) described above, the corresponding position of a test pattern 102 is detected on the basis of the reading resolution (reading pixel pitch) of the scanner forming the reading apparatus (which corresponds to the test pattern reading unit 136 in FIG. 9), and therefore it is not possible to determine the position of the test pattern 102 directly in units of less than one pixel of the reading resolution. Therefore, as described above, a prescribed algorithm is used to calculate the position of each test pattern 102 in units of less than one pixel of the reading resolution (reading pixel pitch).

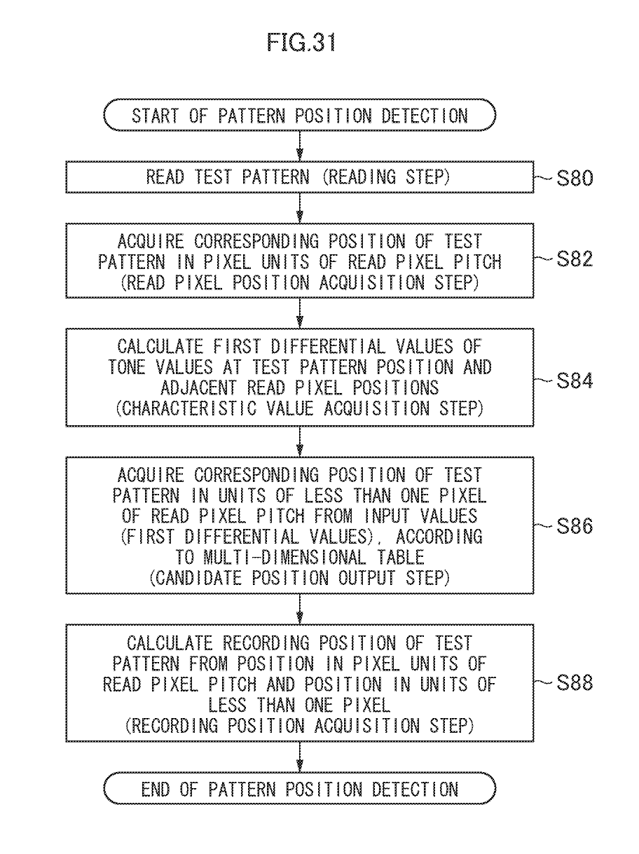

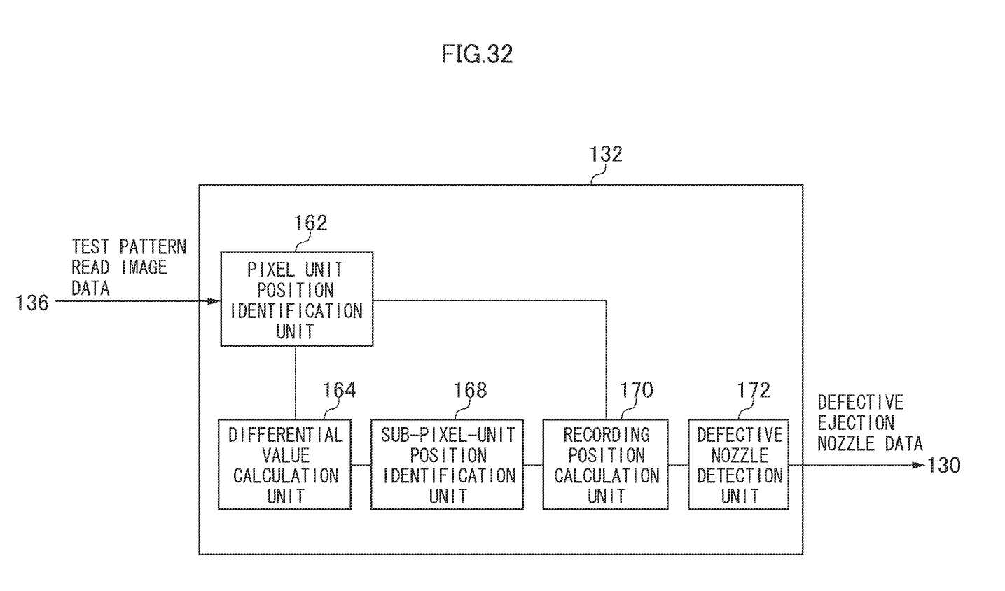

FIG. 31 is a flowchart showing one example of an algorithm for detecting a position of a test pattern 102 in units of less than one pixel of the reading resolution (reading pixel pitch). FIG. 32 is a functional block diagram showing the functional composition of the defective ejection nozzle detection unit 132 (see FIG. 9) which processes the algorithm in FIG. 31.

The recording paper 16 on which test patterns 102 have been formed is read in a prescribed reading direction (X direction) by a scanner (the test pattern reading unit 136 in FIG. 9) at a prescribed read pixel pitch, and the read data of the test patterns 102 based on the read pixel pitch is sent to the defective ejection nozzle detection unit 132 (reading step S80 in FIG. 31).

In the pixel unit position identification unit (read image position acquisition device) 162 of the defective ejection nozzle detection unit 132, the corresponding positions of the test patterns 102 (the corresponding positions in read pixel units) based on the read pixel pitch are acquired from this read data (the read pixel position acquisition step in S82). More specifically, the corresponding positions of the test patterns 102 are determined on the basis of the tone value changes (optical density changes) in the read image data (see FIG. 18).

Thereupon, in the differential value calculation unit (characteristic value acquisition device) 164 of the defective ejection nozzle detection unit 132, the first differential values (characteristic values) of the tone values at the corresponding position of a test pattern 102 and at the adjacent pixel positions which are adjacent to the corresponding position on the basis of the read pixel pitch are calculated from the read data (characteristic value acquisition step S84). In this step, conversion processing to reduce the number of tones in the first differential values (tone values) can be also carried out suitably.

The sub-pixel-unit position identification unit (candidate position acquisition device) 168 of the defective ejection nozzle detection unit 132 refers to the multi-dimensional table and acquires the corresponding position of each test pattern 102 in units of less than one pixel of the read pixel pitch, from the plurality of (four) first differential values which have been calculated (candidate position output step S86). The multi-dimensional table used here reflects the possibility of arrangement of a test pattern 102 for each one of a plurality of candidate positions in units of less than one pixel, as described previously, and if multi-dimensional input values (four first differential values) are applied to this multi-dimensional table, then the sub-pixel unit position which has the highest possibility of arrangement (which shows the best concordance) is derived from amongst the candidate positions. By referring to the multi-dimensional table in this way, a position which is separated from the corresponding position of a test pattern based on the read pixel pitch, by a distance of less than one pixel based on the read pixel pitch, is derived as a candidate position.

In the recording position calculation unit (recording position acquisition device) 170 of the defective ejection nozzle detection unit 132, the recording position of each line pattern on the recording medium is calculated (recording position acquisition step in S88) on the basis of the corresponding positions of the line patterns based on the read pixel pitch (S82) and the candidate positions detected as showing the best concordance (S86). In other words, in specifying the recording position of a test pattern 102, the position in units of the read pixel pitch is acquired from the corresponding position (S82) based on the read pixel pitch which is determined from the read data of the scanner, and the position in units of less than one pixel of the read pixel pitch is acquired from the candidate position which shows the best conformance (S86).

The recording position of the test pattern 102 which has been detected with good accuracy in units of less than one pixel of the read pixel pitch in this way is compared with a reference position (see FIG. 27 and FIG. 28) in the defective nozzle detection unit (defective nozzle detection device) 172 of the defective ejection nozzle detection unit 132, to determine whether or not the corresponding nozzle is a defective ejection nozzle (see S74 in FIG. 30). Information relating to a defective ejection nozzle is sent as defective ejection nozzle data from the defective ejection nozzle detection unit 132 to the defective ejection nozzle judgment unit 130, and is used in the correction processing of the input image data.

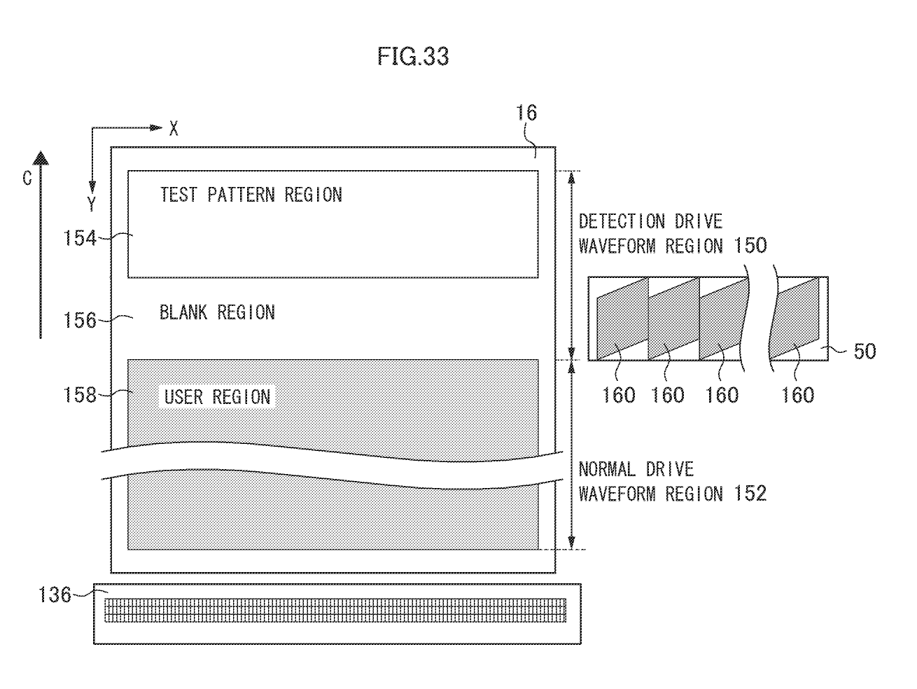

Next, the print layout on the recording paper will be described. FIG. 33 is a diagram showing the layout on the printing paper of a system for detecting and correcting defective ejection nozzles.

The recording paper 16 is divided into a drive waveform region for detection 150 which is provided in an end portion of the paper, and a normal drive waveform region 152. The drive waveform region for detection 150 includes a test pattern region 154 for printing the test pattern 102 described above and a blank region 156, and the normal drive waveform region 152 is formed to include a user region 158 for printing a desired image.

The blank region 156 which is provided between the test pattern region 154 and the user region 158 is a transition section for switching from test pattern printing to normal printing, and the region which is required for this switching in accordance with the conveyance speed of the recording paper 16 is reserved by the blank region 156. In particular, if a test pattern is formed in the test pattern region 154 by using a special drive waveform signal, then a blank region corresponding to the time required to switch from this special drive waveform signal to a normal drive waveform signal is reserved. The blank region 156 is desirably provided so as to correspond at least to the nozzle region 160 of the head 50 in the conveyance direction C of the recording paper. The special drive waveform signal for printing the test pattern 102 is used in order to make it easier to distinguish between a defective ejection nozzle and a normal ejection nozzle, and it is desirable to employ a specially designed drive waveform signal which amplifies the positional error or a drive waveform signal which causes a defective ejection nozzle to function more readily as a non-ejecting nozzle.

Next, the multi-dimensional table used when acquiring the position of a test pattern in units of less than one pixel (see S86 in FIG. 31) will be described in more detail.

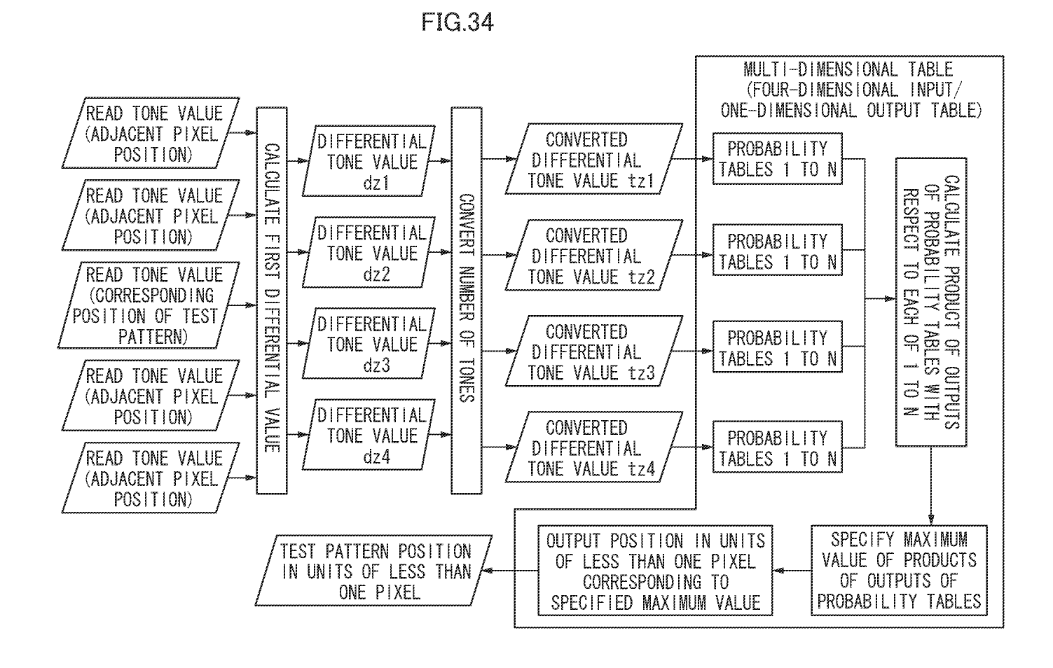

FIG. 34 is a block diagram showing a flow for calculating a position of a test pattern in units of less than one pixel. As stated previously, in the present embodiment, the read tone values of the corresponding position of the test pattern based on the read pixel pitch and of the adjacent pixel positions (four positions) are acquired from the test pattern read results, and first differential values (characteristic values) are calculated from these read tone values to yield the differential tone values dz1, dz2, dz3, dz4. Prescribed processing is carried out to compress the data values, and the like, by converting the number of tones of the differential tone values dz1, dz2, dz3, dz4, thereby yielding the converted differential tone values tz1, tz2, tz3, tz4. The position in units of less than one pixel of the test pattern which is the detection object is then obtained by referring to a multi-dimensional table (the four-dimensional input/one-dimensional output table), using the converted differential tone values tz1, tz2, tz3, tz4 as input values.

The multi-dimensional table used in the present embodiment in this way serves to acquire a sub-pixel unit position of the test pattern directly from a plurality of input values (characteristic values), and this table is prepared and created in advance. Next, the creation and correction of the multi-dimensional table will be described.

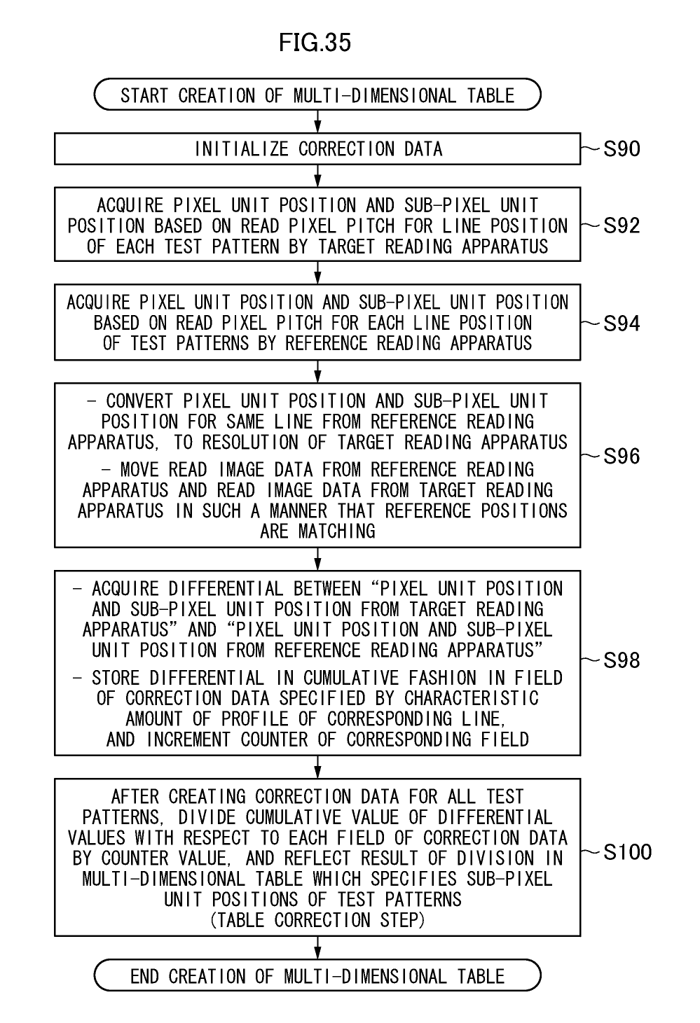

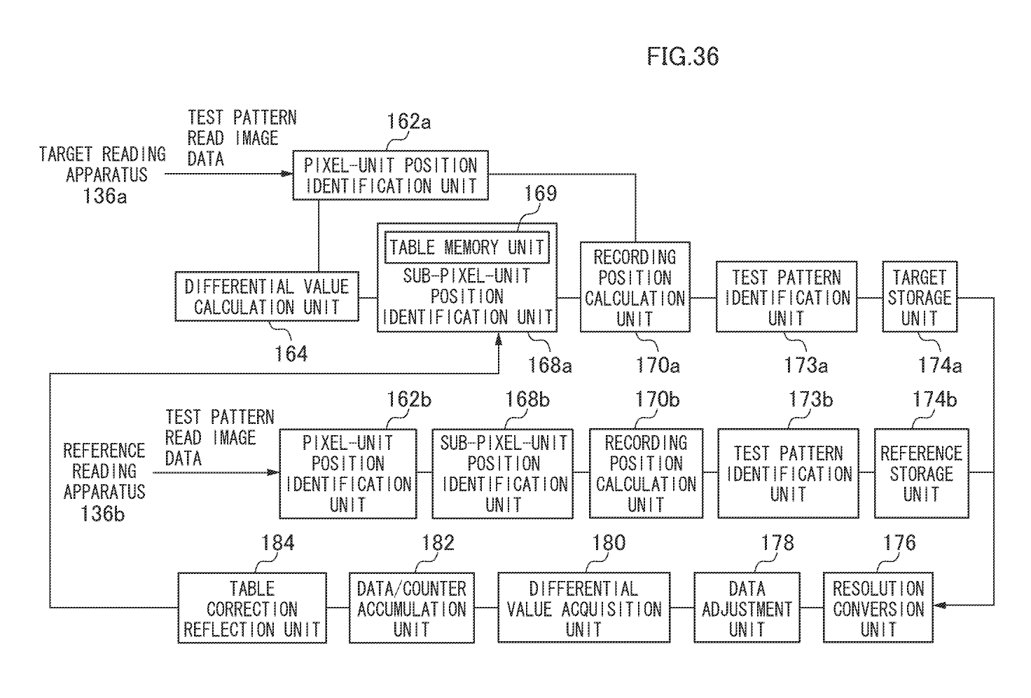

FIG. 35 is a flowchart showing a process for creating a multi-dimensional table. FIG. 36 is a functional block diagram relating to a process for creating a multi-dimensional table.

The blocks shown in FIG. 36 are achieved appropriately by the respective control units of the apparatus, used either independently or in combination with each other. Furthermore, blocks having similar processing functions (for example, the pixel-unit position identification units 162a, 162b, the sub-pixel-unit position identification units 168a, 168b, the recording position calculation units 170a, 170b, the test pattern identification units 173a, 173b, the target storage unit 174a, the reference storage unit 174b, and the like) may be composed by the same device or by separate devices.

Firstly, an initial multi-dimensional table which specifies positions in units of less than one pixel of the read pixel pitch is prepared, and a correction data storage unit which stores data for correcting the initial multi-dimensional table is initialized (S90 in FIG. 35).

This initial table uses a prescribed table in which multi-dimensional input values (characteristic values) are associated with positions in units of less than one pixel based on the read pixel pitch, and it is possible to employ a multi-dimensional table using the conformance function which is described previously. For example, if making use of a table that has been used for a separate type of scanner in order to determine the “conformance” described above, it is possible to store an initial table which uses the overall probability distribution itself as output values of the multi-dimensional table, rather than using the probability distribution for each characteristic amount. In a modification example, an initial table is determined from a probability distribution calculated using a standard printer apparatus and a standard reading apparatus (the “standard” referred to here also includes data conforming to the design values, trial machine data or test machine data), whereupon this initial table is corrected to reflect individual differences between actual apparatuses, and the table can then be used as the initial table.

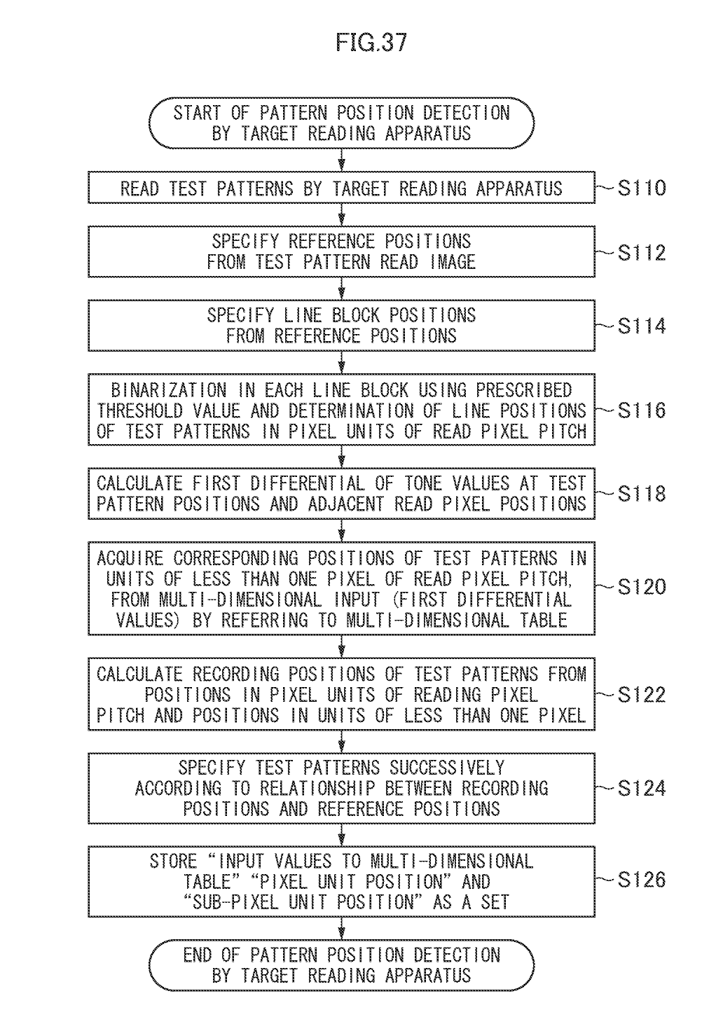

The test patterns are read by the target reading apparatus 136a, and the line positions of the test patterns are acquired on the basis of a pixel unit position and a sub-pixel unit position based on the read pixel pitch (S92). More specifically, the positions of the test patterns are acquired by processing each block unit by the target reading apparatus 136a which performs the various processes described above, in accordance with the flowchart shown in FIG. 37.

More specifically, the test patterns are read in by the target reading apparatus 136a (S110 in FIG. 37), the reference positions (see the test pattern corners CL1, CL2, CR1, CR2 in FIG. 16) are specified from the test pattern read image thus acquired (S112) and the positions of the line blocks (see reference numeral 146 in FIG. 16) are determined from these reference positions (S114). The density tone values of the test pattern read image are binarized within the line block using a prescribed threshold value, and the line positions of the test patterns are specified in pixel units based on the read pixel pitch (S116, see FIG. 18). Each of the steps from S112 to S116 is processed by the pixel-unit position identification unit 162a.

Furthermore, the differential value calculation unit 164 carries out processing to determine first differential values dz1, dz2, dz3, dz4 from the tone values at the corresponding position of the test pattern and the adjacent read pixel positions based on the read pixel pitch as obtained from the test pattern read image, and processing to convert the number of tones of the differential tone values dz1, dz2, dz3, dz4 into conformances so as to compress the number of data values, and the like, and thereby the converted differential tone values tz1, tz2, tz3, tz4 are obtained (S118). In the sub-pixel-unit position identification unit 168a which includes a table memory unit 169, a previously prepared multi-dimensional table (initial table) is referenced on the basis of the multi-dimensional characteristic values determined in this way (the first differential values and the converted differential tone values tz1, tz2, tz3 and tz4), and the corresponding position of the test pattern is obtained in units of less than one pixel of the read pixel pitch (S120).

In the recording position calculation unit 170a, the recording position of the test pattern is calculated from the corresponding position in pixel units of the read pixel pitch (S116) and the corresponding position in units of less than one pixel (S120) which have been determined as described above (S122). In the test pattern identification unit 173a, each test pattern is successively identified on the basis of the relationship between the recording positions and the reference positions determined in this way (see the test pattern corners CL1, CL2, CR1, CR2 in FIG. 16) (see FIG. 26), and the correspondences between the test patterns and the nozzles are established (S124).

The “input values to the multi-dimensional table”, the “position of the test pattern in pixel units” and the “position of the test pattern in units of less than one pixel” which are determined from the read image of the target reading apparatus 136a in this way are stored as a set in the target storage unit 174a (S126). This storage sequence is carried out in line block units, and a storing processing is carried out so that the information is stored so as to have a one-to-one correspondence with the stored data of the reference reading apparatus, which is described hereinafter.

While the corresponding positions of the test patterns are acquired by the target reading apparatus 136a in this way (S92 in FIG. 35), the test patterns are also read in by a reference reading apparatus 136b and the line positions of test patterns are acquired on the basis of a position in pixel units of the read pixel pitch and a position in units of less than one pixel (S94).

The reference reading apparatus 136b has a higher reading resolution (read pixel pitch) than the target reading apparatus 136a, and is able to read the test patterns with a resolution sufficient to reproduce the original profiles of respective lines of the test patterns. The target reading apparatus 136a and the reference reading apparatus 136b can also be provided in the same location and in an integrated fashion (see the test pattern reading unit 136 in FIG. 9), but they may also be provided separately.

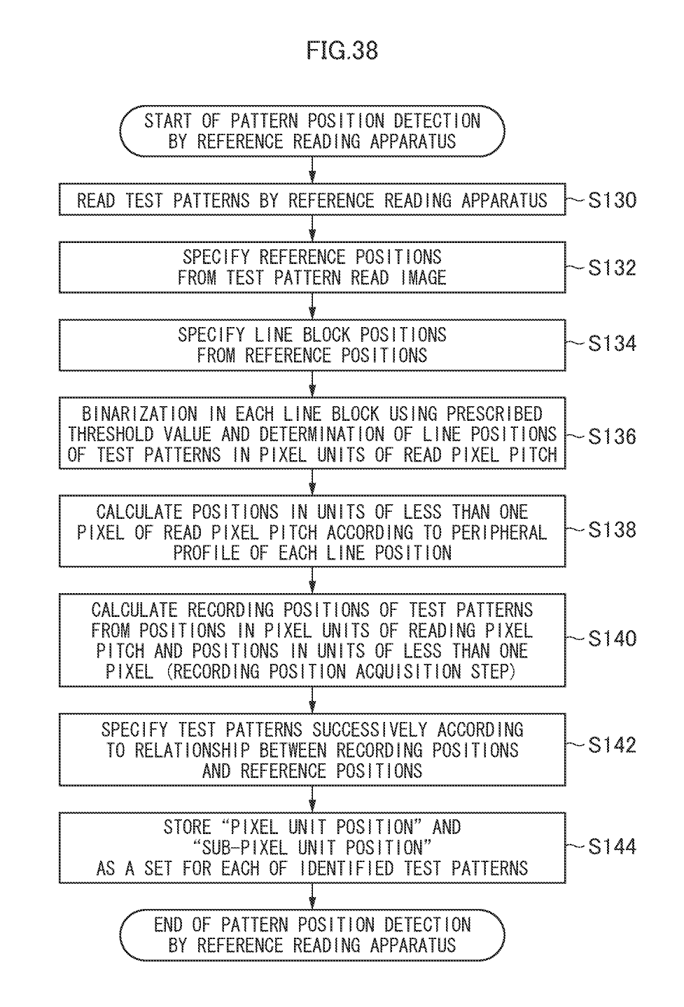

The processing carried out by the reference reading apparatus 136b is performed in nozzle block units, and more specifically, in line with the flowchart shown in FIG. 38, the original profiles are reproduced and the positions of the test patterns are obtained from the shapes of the peripheral profiles which include the respective lines.

More specifically, the test patterns are read in by the reference reading apparatus 136b (S130 in FIG. 38), reference positions (see the test pattern corners CL1, CL2, CR1, CR2 in FIG. 16) are specified from the test pattern read image thus acquired (S132) and the positions of the line blocks (see reference numeral 146 in FIG. 16) are determined from these reference positions (S134). The density tone values of the test pattern read image are binarized within the line blocks using a prescribed threshold value, and the line positions of the test patterns are specified in pixel units of the read pixel pitch (S136, see FIG. 18). This processing (S132 to S136) is carried out in the pixel-unit position identification unit 162b.

Furthermore, in the sub-pixel-unit position identification unit 168b, the corresponding positions of the respective test patterns are calculated in units of less than one pixel of the read pixel pitch, from the test pattern read image, on the basis of the peripheral profiles of the line positions in the test patterns (S138). The method of specifying the sub-pixel unit positions may employ various methods (for example, a method based on the center of the edge position of a line, a method which determines a position showing an extreme value in secondary function fitting, a method using Gaussian function fitting, or the like), but there are no particular restrictions on the method used.

In the recording position calculation unit 170b, the recording position of the test pattern is calculated from the corresponding position in pixel units of the read pixel pitch (S136) and the corresponding position in units of less than one pixel (S138) which have been determined as described above (S140). In the defective nozzle determination unit 172b, the test patterns are successively identified on the basis of the relationship between the recording positions determined in this way and the reference positions (see FIG. 26), and the correspondences between the test patterns and the nozzles are established (S142). The “position of the test pattern in pixel units” and the “position of the test pattern in units of less than one pixel” which are determined from the read image of the reference reading apparatus 136b in this way are stored as a set in the reference storage unit 174b (S144). This storage sequence is carried out in line block units, and a storing processing is carried out so that the information is stored so as to have a one-to-one correspondence with the stored data of the target reading apparatus 136a, which is described above.

In this way, the corresponding positions of the test patterns are acquired by the reference reading apparatus 136b (S94 in FIG. 35). The set data of the pixel unit positions and sub-pixel unit positions based on the reading resolution (read pixel pitch) of the reference reading apparatus 136b which are stored in the reference storage unit 174b is compared with the set data of the pixel unit positions and sub-pixel unit positions based on the reading resolution (read pixel pitch) of the target reading apparatus 136a which are stored in the target storage unit 174a, in respect of the same line (test pattern). More specifically, in a resolution conversion unit 176, the set data of the positions in pixel units and the positions in units of less than one pixel based on the reading resolution of the reference reading apparatus 136b is converted to the resolution of the set data of the positions in pixel units and the positions in units of less than one pixel based on the reading resolution (reading pixel pitch) of the target reading apparatus 136a, thereby processing the data so as to make comparison easier. By this means, the set data of the reference reading apparatus 136b and the set data of the target reading apparatus 136a are adjusted to the same level of resolution (S96).

A statistical amount (simple average position, weighted average position, or the like) including peripheral lines (peripheral lines (peripheral test patterns) which belong to the same line block) is calculated in respect of the line (test pattern) under consideration.

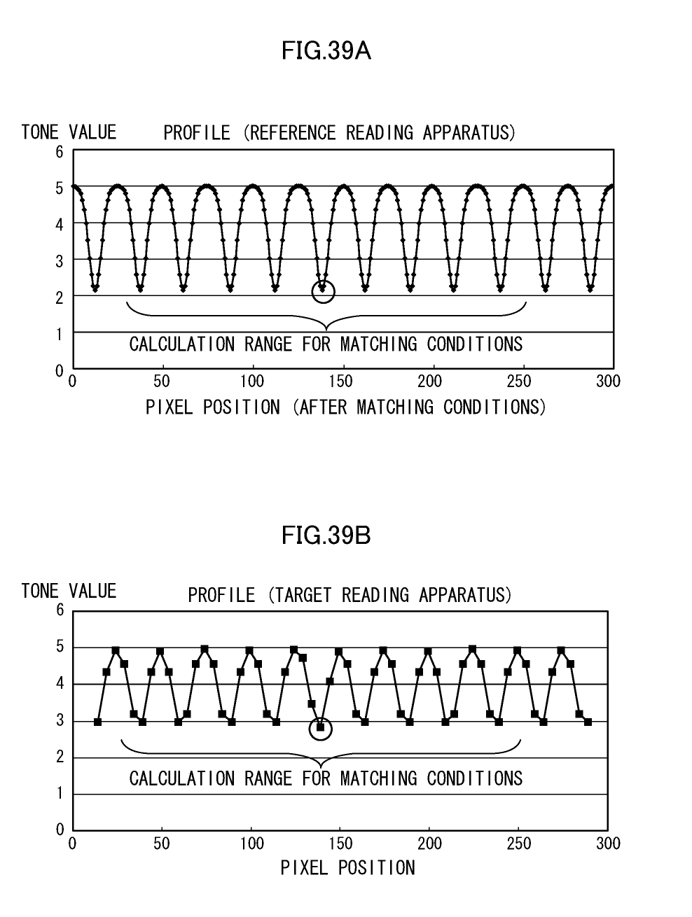

FIGS. 39A and 39B are diagrams for illustrating the matching of the reading conditions by the target reading apparatus and the reading conditions by the reference reading apparatus 136b, and FIG. 39A shows a profile from the reference reading apparatus and FIG. 39B shows a profile from the target reading apparatus.

A statistical amount including peripheral lines (peripheral test patterns) belonging to the same line block (simple average position, weighted average position, and the like) is calculated for the data based on the read image of the target reading apparatus, in a prescribed calculation range used for matching the conditions for the line (test pattern) under consideration. Furthermore, a statistical amount (simple average position, weighted average position, or the like) including peripheral lines belonging to the same block is calculated for the corresponding line, from the line position (test pattern recording position) data which is obtained by converting the data based on the read image from the reference reading apparatus so as to match the resolution of the target reading apparatus. A positional shift amount on the reference reading apparatus 136b side is specified in such a manner that the statistical amount based on the read data from the target reading apparatus matches the statistical amount based on the read data from the reference reading apparatus 136b. In this step, even if there is error in the position recorded by the target storage unit 174a (the pixel unit position and the sub-pixel unit position based on the read pixel pitch), since the characteristic values of a plurality of lines (average position, etc.) are handled statistically, then it is possible to reduce the error in the initial multi-dimensional table and highly accurate positioning is possible. The position is corrected by applying this positional shift amount to the line position under consideration obtained by converting the data based on the read image from the reference reading apparatus so as to match the resolution of the target reading apparatus (S96).

In other words, one or both of the reference positions of the read image data from the reference reading apparatus and the reference positions of the read image data from the target reading apparatus (in the present embodiment, the reference position of the read image data from the reference reading apparatus) is moved in parallel on the basis of the positional shift amount, in such a manner that the respective reference positions match each other as closely as possible (S96). In this way, in respect of a line under consideration, it is possible to adjust the positions from the target reading apparatus (the pixel unit positions and the sub-pixel unit positions of the read pixel pitch) and the positions from the reference reading apparatus 136b (the positions (the pixel unit positions and the sub-pixel unit positions of the read pixel pitch) obtained by converting to the resolution of the target reading apparatus and correcting so that the statistical amounts are matching). These processes are carried out in a data adjustment unit 178.

The differential value acquisition unit 180 then determines, as a correction value, the differential between the two values after positional adjustment based on the statistical amounts. The data/counter accumulation unit 182 then stores this correction value as a cumulative value of correction data relating to the input values to the multi-dimensional table corresponding to the line under consideration, which is stored in the target reading apparatus, and at the same time, increments the counter of the correction data relating to the input values to the multi-dimensional table (S98). In other words, the differential between the “pixel unit position and sub-pixel unit position from the target reading apparatus”, and the “pixel unit position and sub-pixel unit position from the reference reading apparatus 136b” is acquired, and this differential is stored in cumulative fashion in the field of the correction data in the storage unit which is specified by the characteristic amount of the profile of the corresponding line, in addition to which the counter of the corresponding field is incremented by one (+1).

In this way, correction data is created for all of the lines (test patterns), but this is not limited to being based on the data of one test pattern, and it is also possible to calculate a cumulative value and counter relating to the input values to the multi-dimensional table by accumulating data. In a table correction reflection unit 184, the cumulative value of the input value to the multi-dimensional table is divided by the counter, thereby specifying a correction value for the initial table corresponding to the input value, and the correction value thus specified is added to the initial table, thereby creating a corrected table which is saved in the table memory unit 169 (S100). In other words, after creating correction data for all of the test patterns in this way, the cumulative value of the differential values in the respective fields of the correction data storage unit is divided by the counter value, and the result of this division is reflected in the multi-dimensional table used to specify the sub-pixel unit position of the test pattern.

In this way, position information relating to the test pattern including position data in read pixel pitch units and position data in units of less than one pixel based on the read pixel pitch are acquired from the reference reading apparatus, and the multi-dimensional table is corrected on the basis of this position information (table correction step). In particular, in the present embodiment, the position information from the reference reading apparatus which has a high reading resolution and has a smaller pitch than the read pixel pitch of the target reading apparatus is used, and therefore the multi-dimensional table can be corrected appropriately, and it is possible to determine the position of a test pattern with good accuracy, even using a target reading apparatus having low reading resolution.

### Modification Examples

Next, an example in which a multi-dimensional table is created without using a reference reading apparatus will be described.

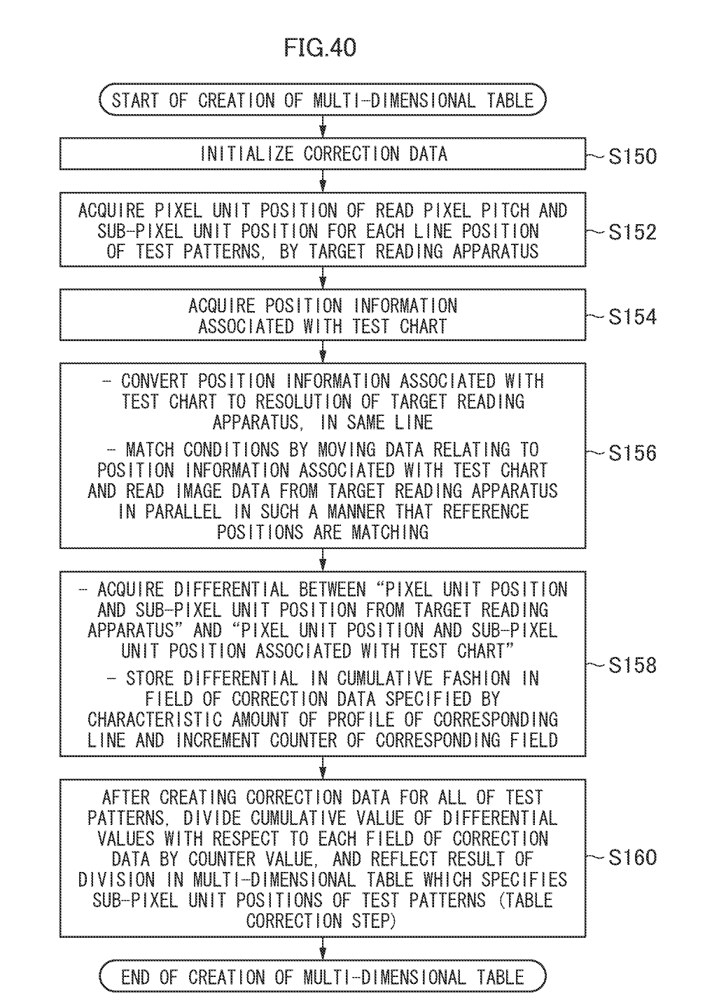

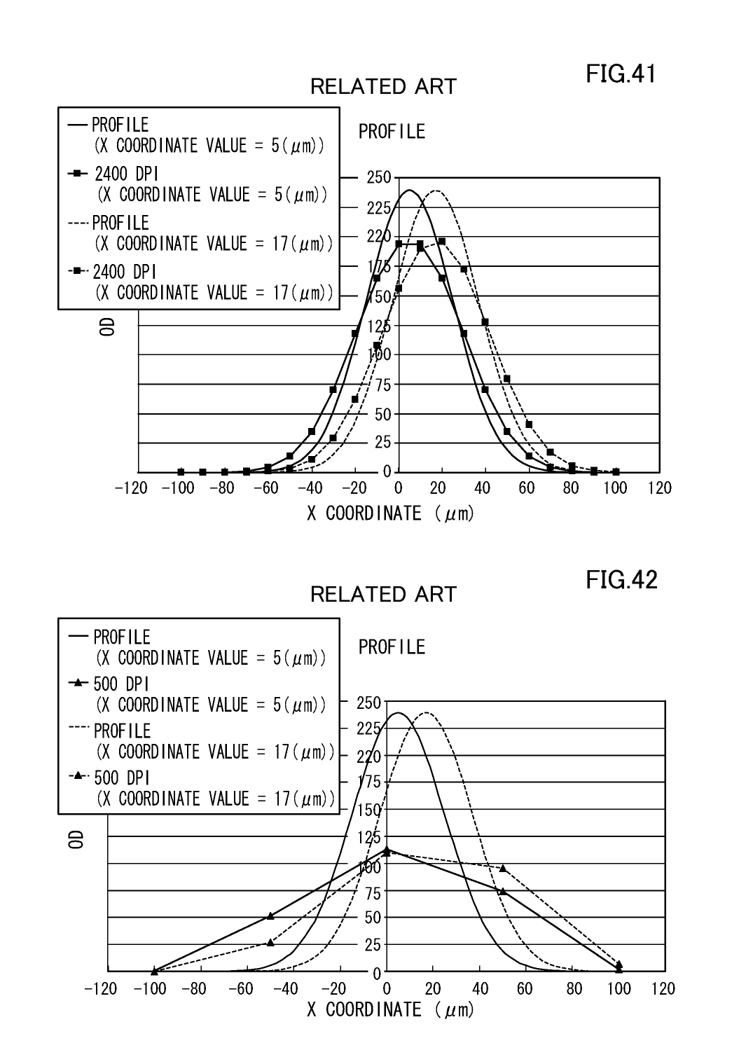

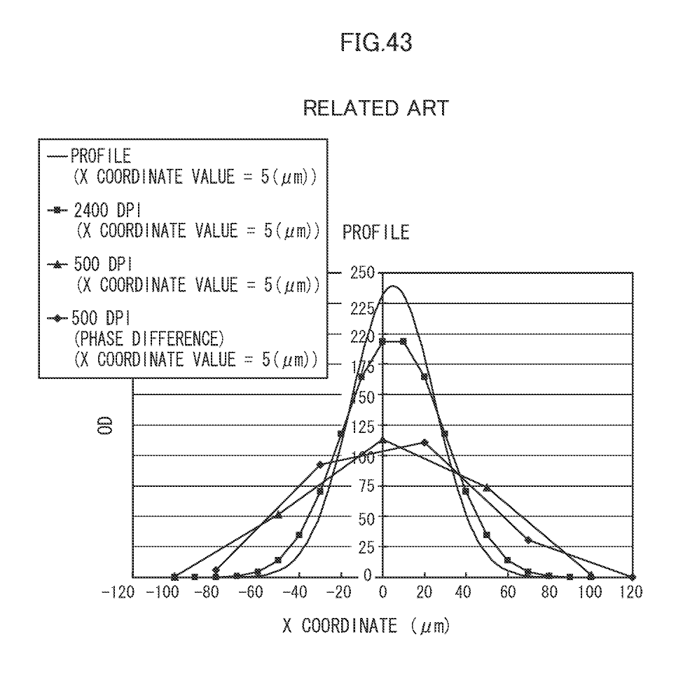

FIG. 40 is a flowchart for describing a sequence for creating a corrected table from an initial table using a test pattern (a test chart created by specifying a position or a test chart with measurement values), without employing a reference reading apparatus. In the present embodiment, a test pattern with which position information is previously associated is used instead of the read image data from a reference reading apparatus (see S94 in FIG. 35).

It is possible to use a test pattern created by specifying a position or a test pattern which already has a pixel unit and sub-pixel unit position based on the read pixel pitch, for example, as the test pattern with which position information is previously associated.

Firstly, similarly to the case of creating the multi-dimensional table based on FIG. 35, an initial multi-dimensional table which specifies positions in units of less than one pixel of the read pixel pitch is prepared, and the correction data storage unit (not illustrated) which stores data for correcting the initial multi-dimensional table is initialized (S150 in FIG. 40). The test pattern is read by the target reading apparatus, and the line positions of the test patterns are acquired on the basis of a pixel unit position and a sub-pixel unit position of the read pixel pitch (S152).

Position information associated with the test pattern which has been determined previously (a pixel unit position and a sub-pixel unit position of the read pixel pitch) is acquired (S154). This position information associated with the test pattern is stored in a prescribed storage unit and can be read out as necessary.

The set data of the pixel unit position and the sub-pixel unit position based on the reading resolution (read pixel pitch) in the position information associated with the test pattern is converted into the resolution of set data of the pixel unit position and the sub-pixel unit position based on the reading resolution (read pixel pitch) of the target reading apparatus, so that the resolution levels of the data in the position information associated with the test pattern and the set data in the target reading apparatus match each other (S156). Furthermore, a statistical amount is calculated for the data based on the read image of the target reading apparatus, in a prescribed calculation range used for matching conditions, and a statistical amount is calculated for the position information associated with the test pattern which has been converted so as to match the reading resolution of the target reading apparatus. A positional shift amount of the position information associated with the test pattern is then specified in such a manner that both statistical amounts are matching. One or both of the reference position in the position information associated with the test pattern and the reference position in the read image data from the target reading apparatus (in the present embodiment, the reference position in the position information associated with the test pattern) is moved in parallel on the basis of the positional shift amount in such a manner that the reference positions match each other as closely as possible (S156).

The differential between the position data after the parallel movement on the basis of the position information associated with the test pattern and the position data from the target reading apparatus is determined as a correction value. This correction value is stored as a cumulative value of the correction data relating to the input value to the multi-dimensional table which corresponds to the line under consideration, and simultaneously with this, the counter of the correction data relating to the input values to the multi-dimensional table is incremented (+1) (S158).

In the present embodiment, correction data is created for all of the lines (test patterns) and a cumulative value and counter relating to the input values to the multi-dimensional table are calculated. By dividing the cumulative value of the input values to the multi-dimensional table by the counter, a correction value for the initial table corresponding to the input values is specified, and by adding the correction value thus specified to the initial table, a corrected table is created (S160).

In this way, it is possible to create a corrected table of higher accuracy by implementing the processing sequence again using a test pattern associated with position information which has been acquired in advance, such as a previous corrected table, or the like, as the initial table.

According to the present embodiments described above, by referring to the multi-dimensional table, it is possible to determine a position having a high degree of conformance with the test pattern 102, with good accuracy in units of less than one pixel of the read pixel pitch, on the basis of tone values (first differential values) which have a correlation with the test pattern 102. By this means, it is possible to specify a position in units of less than one pixel from a very small amount of pixel information, and therefore the position of a test pattern 102 can be identified with a resolution exceeding the reading resolution of the image reading apparatus, even if the reading resolution of the image reading apparatus (test pattern reading unit 136) is low. Therefore, it is possible to use an image reading apparatus having a low resolution which is relatively inexpensive, and it is possible to achieve both cost reduction of the apparatus and high image reading accuracy.

Further, nozzles suffering an ejection defect can be detected accurately from the recording positions of the test pattern 102 which can be determined accurately in units of less than one pixel of the read pixel pitch. Consequently, it is possible to stop defective ejection nozzles which have a large depositing position error and are problematic in terms of image quality, and perform image correction appropriately in respect of these defective ejection nozzles. Therefore, it is possible to print a high-quality image in which banding and non-uniformities are prevented more reliably, on the recording medium.

Furthermore, an image reading apparatus having a compact structure is especially desirable in an inkjet recording apparatus (liquid ejection apparatus) such as that of the present embodiment which detects nozzles having ejection defects from the recording positions of test patterns 102, since the installation space for the respective units is limited. Therefore, since the apparatus composition can be simplified by adopting an image reading apparatus of low resolution which has a simple structure, the technology relating to the present embodiment is extremely useful.

An embodiment described above merely presents one mode of the present invention, and the present invention can be applied in other methods and apparatuses.

For example, in the embodiment described above, the present invention is applied to an inkjet recording apparatus, but the present invention can also be applied to other apparatuses which eject liquid from a plurality of ejection units, such as an application apparatus, coating apparatus, wire forming apparatus, fine structure forming apparatus, or the like, and the present invention is widely applicable as a technology for measuring liquid depositing positions on an ejection receiving medium.

Furthermore, an example is described in which density tone values (first differential values) are used as characteristic values having a correlation with the test patterns (line patterns), but it is also possible to use other factors as characteristic values. For example, it is also possible to use various values calculated on the basis of the tone values as characteristic values; for instance, a value Y calculated by combining values derived from RGB color data (Y=αR×R+αG×G+αB×B+αC), a value D′ obtained by converting a tone value D by using a prescribed table (Scanner LUT:a look-up table for eliminating scanner-dependent individual differences in the tonal characteristics), where D′=Scanner LUT [D], or a ratio R_{(Di/Di+1)} between the tone values (Dᵢ and Dᵢ₊₁) of mutually adjacent pixels (i and i+1), (R_{(Di/Di+1)}=Dᵢ/Dᵢ₊₁), or the like. Moreover, it is of course also possible to use a ratio of values calculated on the basis of tone values as a characteristic value. For example, it is possible to narrow the relationship to positions in units of less than one pixel of the read pixel pitch, by means of statistical processing such as a correlation coefficient, and to use the characteristic value having the high correlation by applying data mining technology. For example, if the characteristic amount before narrowing it down by data mining is Dᵢ×Dᵢ₊₁× . . . ×Dᵢ₊ₖ (where k is separate candidates, such as 1, 2, 3, 4, etc.), then it is possible to use (Dᵢ×Dᵢ₊₁× . . . ×Dᵢ₊ₖ)^{1/(k+1)}, where k represents separate candidates, such as 1, 2, 3, 4, etc., as a characteristic value.

Furthermore, in the example described above, the candidate position showing the best degree of conformance is identified on the basis of the product of the conformances of the corresponding position of the test pattern and the adjacent pixel positions (see Formula 3), but it may also be identified on the basis of the sum of the conformances, or a value multiplied by a prescribed coefficient (a value to which a gradient is applied in accordance with the position).

Furthermore, in the examples described above, a characteristic value is calculated from read data in a total of four adjacent pixel positions, namely two each before and after the corresponding position of the test pattern, but a characteristic value may also be calculated from read data for a greater number of adjacent pixel positions or read data for a smaller number of adjacent pixel positions.

Consequently, the number of input values (characteristic values) to the multi-dimensional table is not limited in particular.

Furthermore, the method of determining the conformance distribution is not limited to the examples described above, and it is possible to employ various methods, and for example, the conformance distribution can also be determined by method of a simple method as described below. More specifically, the line profile is defined as a simplified shape (for example, a triangular or trapezoid shape, or the like), and the variation in the shape is defined (for example, the “figure height” corresponds to the line profile density, the “figure width” corresponds to the width of the line profile, and the “figure deformation” corresponds to the asymmetry of the distribution). A characteristic amount is then calculated by applying a variation to the defined figure, and the variation corresponding to noise during reading is applied to the characteristic amount. The central position of the figure is defined as the center of gravity before variation, or the like. In this way, it is possible to determine the relationship between the characteristic amount and the central position as described above.

The fine pattern position detection method, the defective nozzle detection method and the liquid ejection method relating to the present embodiment can be realized as a computer program which causes the system controller 64, the print controller 80, or another control unit of the inkjet recording apparatus 10 to execute the processing described above, and as a recording medium and a program product on which this computer program is recorded.

It should be understood that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A fine pattern position detection method comprising:
a reading step of reading line patterns formed on a recording medium, at a prescribed read pixel pitch in a prescribed reading direction to acquire read data;
a read pixel position acquisition step of acquiring from the read data corresponding positions of the line patterns based on the read pixel pitch;
a characteristic value acquisition step of acquiring, from the read data, characteristic values at the corresponding positions of the line patterns and characteristic values at adjacent pixel positions which are adjacent to each of the corresponding positions of the line patterns according to the read pixel pitch;
a candidate position output step of applying the characteristic values at the corresponding positions of the line patterns and the characteristic values at the adjacent pixel positions, to a position table in which the characteristic value at each of the corresponding positions of the line patterns and the characteristic values at the adjacent pixel positions are associated with a candidate position which is a candidate position having highest possibility of arrangement of each of the line patterns and which is assigned at a distance shorter than the read pixel pitch from the corresponding position of each of the line patterns, so as to output the candidate position of each of the line patterns; and
a recording position acquisition step of calculating a recording position of each of the line patterns on the recording medium, from the corresponding position of each of the line patterns based on the read pixel pitch and the output candidate position of each of the line patterns.

2. The fine pattern position detection method as defined in claim 1, wherein:
the candidate position each of the line patterns is separated from the corresponding position of each of the line patterns by a distance shorter than one pixel based on the read pixel pitch; and
in the recording position acquisition step, the recording position of each of the line patterns in read pixel pitch units is determined from the corresponding position based on the read pixel pitch, and the recording position of each of the line patterns in units of less than one pixel based on the read pixel pitch is determined from the candidate position having the highest possibility of arrangement of each of the line patterns.

3. The fine pattern position detection method as defined in claim 1, wherein the position table reflects:
a conformance deduction step of deducing conformances which are prepared for a plurality of candidate positions respectively and each represent a possibility of arrangement of each of the line patterns, from the characteristic value at the corresponding position of each of the line patterns and the characteristic values at the adjacent pixel positions, according to conformance functions which relate to respective multi-dimensional input values, are prepared for the plurality of candidate values and associate the characteristic values with the conformances; and
a candidate position acquisition step of detecting the candidate position displaying the best conformance, according to the conformances deduced for the plurality of candidate positions respectively, and
wherein in the candidate position output step, the characteristic value at the corresponding position of each of the line patterns and the characteristic value at the adjacent pixel positions are input to the position table as the multi-dimensional input values, and the candidate position displaying the best conformance is output.

4. The fine pattern position detection method as defined in claim 1, wherein the line patterns formed on the recording medium each have a width substantially equal to the read pixel pitch in the reading direction.

5. The fine pattern position detection method as defined in claim 1, wherein the line patterns formed on the recording medium each have a width of not more than five times the read pixel pitch in the reading direction.

6. The fine pattern position detection method as defined in claim 1, wherein the characteristic value at the corresponding position of each of the line patterns and the characteristic values at the adjacent pixel positions are calculated from the read data at the corresponding position of each of the line patterns and the read data at two adjacent pixel positions on a forward side and two adjacent pixel positions on a rearward side of the corresponding position of each of the line patterns in terms of the reading direction according to the read pixel pitch.

7. The fine pattern position detection method as defined in claim 1, wherein:
in the reading step, the read data relating to optical density is acquired; and
the characteristic values are based on the optical density.

8. The fine pattern position detection method as defined in claim 1, wherein the characteristic values are based on a first differential value of the read data.

9. The fine pattern position detection method as defined in claim 1, wherein:
on the recording medium, a detection bar which has a prescribed width and extends continuously in the reading direction is formed so as to correspond to the line patterns;
in the reading step, the line patterns and the detection bar are read simultaneously to acquire the read data relating to optical density; and
in the read pixel position acquisition step, a position of the detection bar is determined from change in the optical density indicated by the read data, and the corresponding position of each of the line patterns is acquired from the determined position of the detection bar and a positional relationship between the detection bar and each of the line patterns.

10. The fine pattern position detection method as defined in claim 1, further comprising a table correction step of correcting the position table according to the recording position of each of the line patterns calculated in the recording position acquisition step and position information including position data in read pixel pitch units and position data in units of less than one pixel based on the read pixel pitch of the line patterns.

11. The fine pattern position detection method as defined in claim 10, wherein the position information includes the position data in the read pixel pitch units and the position data in units of less than one pixel based on the read pixel pitch of the line patterns, both the position data being obtained by reading the line patterns at a resolution based on a smaller pitch than the read pixel pitch.

12. The fine pattern position detection method as defined in claim 10, wherein the position information includes the position data in read pixel pitch units and the position data in units of less than one pixel based on the read pixel pitch of the line patterns, both the position data being acquired in advance in respect of the line patterns.

13. A defective nozzle detection method comprising:
the fine pattern position detection method as defined in claim 1;
a pattern forming step of ejecting liquid from nozzles to form the line patterns corresponding to the nozzles respectively, on the recording medium; and
a defective nozzle detection step of detecting a defective ejection nozzle from among the nozzles, according to reference positions which form reference for depositing positions of the liquid on the recording medium and which are set for the nozzles respectively, and the recording position of each of the line patterns calculated in the recording position acquisition step.

14. The defective nozzle detection method as defined in claim 13, wherein the reference position for each of the nozzles is calculated according to the recording positions of the line patterns for adjacent nozzles to each of the nozzles.

15. A liquid ejection method comprising:
the defective nozzle detection method as defined in claim 13;
a reception step of receiving input data;
a correction step of correcting the received input data; and
an ejection step of ejecting the liquid from the nozzles according to the corrected input data, wherein
in the correction step, the input data is corrected in such a manner that ejection of the liquid from the defective ejection nozzle detected in the defective nozzle detection step is compensated by another nozzle and the liquid is not ejected from the defective ejection nozzle.

16. A fine pattern position detection apparatus comprising:
a reading device which reads line patterns formed on a recording medium, at a prescribed read pixel pitch in a prescribed reading direction, to acquire read data;
a read pixel position acquisition device which acquires, from the read data, corresponding positions of the line patterns based on the read pixel pitch;
a characteristic value acquisition device which acquires, from the read data, a characteristic value at the corresponding position of each of the line patterns and characteristic values at adjacent pixel positions which are adjacent to the corresponding position of each of the line patterns according to the read pixel pitch;
a candidate position output device in which the characteristic values at the corresponding positions of the line patterns and the characteristic values at the adjacent pixel positions are applied to a position table in which the characteristic value at each of the corresponding positions of the line patterns and the characteristic values at the adjacent pixel positions are associated with a candidate position which is a candidate position having the highest possibility of arrangement of each of the line patterns and which is assigned at a distance shorter than the read pixel pitch from the corresponding position of each of the line patterns, so as to output the candidate position of each of the line patterns; and
a recording position acquisition device which calculates a recording position of each of the line patterns on the recording medium, from the corresponding position of each of the line patterns based on the read pixel pitch and the output candidate position of each of the line patterns.

17. A defective nozzle detection apparatus comprising:
the fine pattern position detection apparatus as defined in claim 16:
a pattern forming device which eject liquid from nozzles to form the line patterns corresponding to the respective nozzles; and
a defective nozzle detection device which detects a defective ejection nozzle from among the nozzles, according to reference positions which form reference for depositing positions of the liquid on the recording medium and which are set for the nozzles respectively, and the recording position of each of the line patterns calculated by the recording position acquisition device.

18. A liquid ejection apparatus comprising:
the defective nozzle detection apparatus as defined in claim 17;
a reception device which receives input data;
a correction device which corrects the received input data; and
an ejection device which ejects the liquid from the nozzles according to the corrected input data, wherein
the correction device corrects the input data in such a manner that ejection of the liquid from the defective ejection nozzle detected by the defective nozzle detection device is compensated by another nozzle and the liquid is not ejected from the defective ejection nozzle.
